(19) United States
(12) Patent Application Publication
(10) Pub. No.: US 2011/0189432 A1
(43) Pub. Date: Aug. 4, 2011

(54) EPOXY RESIN COMPOSITION, PREPREG, CURED BODY, SHEET-LIKE MOLDED BODY, LAMINATE AND MULTILAYER LAMINATE

(75) Inventors: Nobuhiro Goto, Ibaraki (JP); Masaru Heishi, Ibaraki (JP); Hidenobu Deguchi, Ibaraki (JP); Takayuki Kobayashi, Ibaraki (JP); Junnosuke Murakami, Ibaraki (JP)

(73) Assignee: SEKISUI CHEMICAL CO., LTD., Osaka (JP)

(21) Appl. No.: 13/056,392

(22) PCT Filed: Jul. 29, 2009
(86) PCT No.: PCT/JP2009/063477

§ 371 Date: Apr. 18, 2011

(30) Foreign Application Priority Data
Jul. 29, 2008 (JP) 2008-198036

(51) Int. Cl. B32B 3/00; C08L 63/00; C08K 9/06

(52) U.S. Cl. 428/141; 523/443

(57) ABSTRACT

Provided is an epoxy resin composition capable of reducing the surface roughness of the surface of a roughening-treated cured body.

The epoxy resin composition includes an epoxy resin, a curing agent, and a silica component obtained by performing a surface treatment on silica particles using a silane coupling agent; and the epoxy resin composition does not include a curing accelerator, or includes a curing accelerator at a content equal to or less than 3.5 parts by weight to a total of 100 parts by weight of the epoxy resin and the curing agent. Mean particle diameter of the silica particles is equal to or less than 1 μm. An amount B (g) of the silane coupling agent used for surface treatment, per 1 g of the silica particles in the silica component, is within a range between 10% to 80% with regard to a value C (g) per 1 g of the silica particles, which is calculated by the following formula (X).

C (g)/1 g of Silica Particles=[Specific Surface Area of Silica Particles (m²/g)/Minimum Area Coated by Silane Coupling Agent (m²/g)] Formula (X)

### TECHNICAL FIELD

The present invention relates to an epoxy resin composition including an epoxy resin, a curing agent, and a silica component, and in more detail, relates to, for example, an epoxy resin composition used for obtaining a cured body formed on a surface of a copper plating layer and the like, and to a prepreg, a cured body, a sheet-like formed body, a laminated plate, and a multilayer laminated plate using the epoxy resin composition.

### BACKGROUND ART

Conventionally, various thermosetting resin compositions are used to form multilayer substrates, semiconductor devices, or the like.

For example, the following patent literature 1 discloses a thermosetting resin composition including a thermosetting resin, a curing agent, and a filler whose surface is treated with an imidazole silane. There are imidazole groups existing on the surface of the above described filler. The imidazole groups act as curing catalysts and as reaction starting points. Therefore, strength of a cured object of the above described thermosetting resin composition can be increased. Additionally, patent literature 1 discloses that the thermosetting resin composition is useful for applications needing adherence, such as adhesives, sealing agents, coating materials, lamination materials, and forming materials.

The following patent literature 2 discloses an epoxy resin composition including an epoxy resin, a phenol resin, a curing agent, an inorganic filler, and an imidazole silane in which a Si atom and a N atom are not directly coupled. It is disclosed here that adhesiveness of a cured object of the epoxy resin composition to a semiconductor chip is high, and that it is difficult to separate the cured object from a semiconductor chip and the like even after IR reflow, since moisture resistance of the cured object is high.

Furthermore, the following patent literature 3 discloses an epoxy resin composition including an epoxy resin, a curing agent, and a silica. The silica is treated with an imidazole silane, and the mean particle diameter of the silica is equal to or less than 5 μm. By curing the epoxy resin composition, and then performing a roughening treatment thereon, the silica can be easily eliminated without etching the resin to a large degree. Therefore, the surface roughness of the surface of the cured object can be reduced. In addition, adhesiveness between the cured object and a copper plating can be increased.

### CITATION LIST

### Patent Literature

[PTL 1] Japanese Laid-Open Patent Publication No. H09-169871
[PTL 2] Japanese Laid-Open Patent Publication No. 2002-128872
[PTL 3] Publication WO2007/032424

### SUMMARY OF THE INVENTION

### Problems to be Solved by the Invention

Wirings consisting of metals such as copper are often formed on the surfaces of the cured bodies obtained by using the above described thermosetting resin compositions. In recent years, miniaturization is progressing for wirings formed on the surfaces of such cured bodies. Namely, there are further decreases in L/S, in which a dimension (L) is a width direction of wirings and dimension (S) is a width direction of a portion on which wirings are not formed. Therefore, further decrease in the linear expansion coefficient of a cured body has been discussed. Conventionally, a large amount of a filler such as silica has generally been blended in a thermosetting resin composition in order to reduce the linear expansion coefficient of a cured body.

However, when a large amount of silica is blended in, the silica can easily aggregate. Therefore, during a roughening treatment, the aggregated silica is eliminated as a lump, and thereby increasing the surface roughness.

Thermosetting resin compositions disclosed in patent literatures 1 to 3 include components obtained by performing a surface treatment on a filler or an inorganic filler such as silica using an imidazole silane. Even when such a surface-treated inorganic filler is used, there are cases where the surface roughness is not reduced for the surface of a cured body obtained by performing a roughening treatment.

An objective of the present invention is to provide an epoxy resin composition which is capable of reducing the surface roughness of the surface of a cured body obtained by performing a roughening treatment, and which is capable of increasing the adhesive strength between the cured body and the metal layer when a metal layer is formed on the surface of the roughening-treated cured body; and to provide a prepreg, a cured body, a sheet-like formed body, a laminated plate, and a multilayer laminated plate using the epoxy resin composition.

### Solution to the Problems

The present invention can provide an epoxy resin composition, which comprises an epoxy resin, a curing agent, and a silica component obtained by performing a surface treatment on silica particles using a silane coupling agent; and which does not comprise a curing accelerator, or comprises a curing accelerator at equal to or less than 3.5 parts by weight to a total of 100 parts by weight of the epoxy resin and the curing agent; and in which a mean particle diameter of the silica particles is equal to or less than 1 μm; and in which an amount B (g) of the silane coupling agent used for surface treatment, per 1 g of the silica particles in the silica component, is within a range between 10% to 80% with regard to a value C (g) per 1 g of the silica particles, which is calculated by the following formula (X).

C (g)/1 g of Silica Particles=[Specific Surface Area of Silica Particles (m²/g)/Minimum Area Coated by Silane Coupling Agent (m²/g)] Formula (X)

A specific aspect of the epoxy resin composition according to the present invention comprises the silica component within a range between 10 to 400 parts by weight to a total of 100 parts by weight of the epoxy resin and the curing agent.

In another specific aspect of the epoxy resin composition according to the present invention, the curing agent is at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins.

In another specific aspect of the epoxy resin composition according to the present invention, the curing accelerator is an imidazole compound.

In still another specific aspect of the epoxy resin composition according to the present invention, the curing accelerator is at least one type selected from the group consisting of 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2,4-diamino-6-[2′-methyl imidazolyl-(1′)]ethyl-s-triazine, 2,4-diamino-6-[2′-undecyl imidazolyl-(1′)]-ethyl-s-triazine, 2,4-diamino-6-[2′-ethyl-4′-methyl imidazolyl-(1′)]-ethyl-s-triazine, adducts of 2,4-diamino-6-[2′-methyl imidazolyl-(1′)]ethyl-s-triazine isocyanuric acid, adducts of 2-phenyl imidazole isocyanuric acid, adducts of 2-methyl imidazole isocyanuric acid, 2-phenyl-4,5-dihydroxymethylimidazole, and 2-phenyl-4-methyl-5-dihydroxymethylimidazole.

Another specific aspect of the epoxy resin composition according to the present invention further comprises an imidazole silane compound within a range between 0.01 to 3 parts by weight to a total of 100 parts by weight of the epoxy resin and the curing agent.

Another specific aspect of the epoxy resin composition according to the present invention further comprises an organically modified sheet silicate within a range between 0.01 to 3 parts by weight to a total of 100 parts by weight of the epoxy resin and the curing agent.

A prepreg of the present invention is a prepreg obtained by impregnation of the epoxy resin composition formed according to the present invention, to a porous base material.

Furthermore, provided with the present invention is a cured body obtained by preliminary-curing the epoxy resin composition formed according to the present invention or a prepreg obtained by impregnation of the epoxy resin composition to a porous base material, and then performing a roughening treatment; the cured body having a surface on which a roughening treatment is conducted and which has an arithmetic mean roughness Ra equal to or less than 0.3 μm and a ten-point mean roughness Rz equal to or less than 3.0 μm.

A sheet-like formed body of the present invention is a sheet-like formed body obtained by forming, into a sheet, the epoxy resin composition formed according to the present invention, a prepreg obtained by impregnation of the epoxy resin composition to a porous base material, or a cured body obtained by preliminary-curing the epoxy resin composition or the prepreg and then performing a roughening treatment thereon.

A laminated plate of the present invention comprises the sheet-like formed body formed according to the present invention, and a metal layer laminated on at least one surface of the sheet-like formed body.

In a specific aspect of the laminated plate of the present invention, the metal layer is formed as a circuit.

A multilayer laminated plate of the present invention comprises a plurality of the sheet-like formed bodies of the present invention forming a lamination, and at least one metal layer which is interposed between the sheet-like formed bodies.

A specific aspect of the multilayer laminated plate of the present invention further comprises a metal layer laminated on an outside surface of an outermost sheet-like formed body out of the sheet-like formed bodies.

In another specific aspect of the multilayer laminated plate of the present invention, the metal layer is formed as a circuit.

### Advantageous Effects of the Invention

An epoxy resin composition according to the present invention is capable of reducing the surface roughness of the surface of a cured body, since it includes a silica component obtained by performing a surface treatment on silica particles with a mean particle diameter equal to or less than 1 μm using a specific amount of a silane coupling agent. Furthermore, when a metal layer is formed on the surface of the cured body obtained by performing a roughening treatment, the adhesive strength between the cured body and the metal layer can be increased.

### BRIEF DESCRIPTION OF THE DRAWINGS

FIG. 1 is a partially-cut front sectional view schematically showing a surface of a cured body obtained by preliminary-curing an epoxy resin composition according to one embodiment of the present invention, and then, by performing a roughening treatment.

FIG. 2 is a partially-cut front sectional view showing a state where a metal layer is formed on the surface of the cured body shown in FIG. 1.

FIG. 3 is a partially-cut front sectional view schematically showing a multilayer laminated plate formed by using an epoxy resin composition according to one embodiment of the present invention.

### DESCRIPTION OF EMBODIMENTS

The inventors of the present application have discovered that the surface roughness of the surface of a cured body obtained by performing a roughening treatment can be reduced by using a composition including an epoxy resin, a curing agent, and a silica component obtained by performing a surface treatment on silica particles with a mean particle diameter equal to or less than 1 μm using a specific amount of the silane coupling agent described above; and have perfected the present invention.

Specifically, it has been discovered that to have an amount B (g) of the silane coupling agent used for surface treatment, per 1 g of the silica particles in the silica component, to be within a range between 10% to 80% with regard to a value C (g) per 1 g of the silica particles, which is calculated by formula (X), is an extremely important requirement for reducing the surface roughness of the surface of the cured body obtained by performing a roughening treatment.

The epoxy resin composition according to the present invention includes the epoxy resin, the curing agent, and the silica component obtained by performing a surface treatment on the silica particles using the silane coupling agent. Furthermore, the epoxy resin composition according to the present invention includes a curing accelerator as an optional component. In the following, components included in the epoxy resin composition will be described.

(Epoxy Resin)

An epoxy resin included in the epoxy resin composition according to the present invention is an organic compound including at least one epoxy group (oxirane ring).

The number of epoxy groups in a single molecule of the epoxy resin is equal to or more than one. The number of the epoxy groups is preferably equal to or more than two.

A conventionally well-known epoxy resin can be used as the epoxy resin. With regard to the epoxy resin, a single type may be used by itself, or a combination of two or more types may be used. Furthermore, the epoxy resin also includes an epoxy resin derivative and a hydrogenated compound of an epoxy resin.

The epoxy resin includes, for example, an aromatic epoxy resin (1), an alicyclic epoxy resin (2), an aliphatic epoxy resin (3), a glycidyl ester type epoxy resin (4), a glycidyl amine type epoxy resin (5), a glycidyl acrylic type epoxy resin (6), an polyester type epoxy resin (7), or the like.

The aromatic epoxy resin (1) includes, for example, a bisphenol type epoxy resin, a novolac type epoxy resin, or the like.

The bisphenol type epoxy resin includes, for example, a bisphenol A type epoxy resin, a bisphenol F type epoxy resin, a bisphenol AD type epoxy resin, a bisphenol S type epoxy resin, or the like.

The novolac type epoxy resin includes a phenol novolac type epoxy resin, a cresol novolac type epoxy resin, or the like.

Furthermore, as the aromatic epoxy resin (1), an epoxy resin or the like having, in a main chain, an aromatic ring such as naphthalene, naphthalene ether, biphenyl, anthracene, pyrene, xanthene, or indole, can be used. Additionally, an indole-phenol co-condensation epoxy resin, a phenol aralkyl type epoxy resin, or the like can be used. In addition, an epoxy resin or the like consisting of an aromatic compound such as a trisphenol-methane triglycidyl ether can be used.

The alicyclic epoxy resin (2) includes, for example, 3,4-epoxy cyclohexylmethyl-3,4-epoxy cyclohexane carboxylate, 3,4-epoxy-2-methylcyclohexylmethyl-3,4-epoxy-2-methylcyclohexane carboxylate, bis(3,4-epoxy cyclohexyl)adipate, bis(3,4-epoxy cyclohexylmethyl)adipate, bis(3,4-epoxy-6-methylcyclohexylmethyl)adipate, 2-(3,4-epoxy cyclohexyl-5,5-spiro-3,4-epoxy)cyclohexanone-m-dioxane, bis(2,3-epoxy cyclopentyl)ether, or the like.

Commercial items of the alicyclic epoxy resin (2) include, for example, “EHPE-3150” (softening temperature 71° C.), which is a product name and which is manufactured by Daicel Chemical Industries, Ltd., or the like.

The aliphatic epoxy resin (3) includes, for example, a diglycidyl ether of neo pentylglycol, a diglycidyl ether of 1,4-butanediol, a diglycidyl ether of 1,6-hexanediol, a triglycidyl ether of glycerin, a triglycidyl ether of trimethylolpropane, a diglycidyl ether of polyethylene glycol, a diglycidyl ether of polypropylene glycol, a poly glycidyl ether of a long chain polyol, or the like.

The long chain polyol preferably includes a poly oxyalkylene glycol or poly tetramethylene ether glycol. Furthermore, the carbon number of an alkylene group of the polyoxyalkylene glycol is preferably within a range between 2 to 9, and more preferably within a range between 2 to 4.

The glycidyl ester type epoxy resin (4) includes, for example, phthalic acid diglycidyl ester, tetrahydrophthalic acid diglycidyl ester, hexahydrophthalic acid diglycidyl ester, diglycidyl-p-oxybenzoic acid, a glycidyl ether-glycidyl ester of salicylic acid, a dimer acid glycidyl ester, or the like.

The glycidyl amine type epoxy resin (5) includes, for example, triglycidyl isocyanurate, a N,N′-diglycidyl derivative of cyclic alkylene urea, a N,N,O-triglycidyl derivative of p-aminophenol, a N,N,O-triglycidyl derivative of m-aminophenol, or the like.

The glycidyl acrylic type epoxy resin (6) includes, for example, a copolymer of glycidyl (meth)acrylate and a radical polymerizable monomer, or the like. The radical polymerizable monomer includes ethylene, vinyl acetate, a (meth)acrylic ester, or the like.

The polyester type epoxy resin (7) includes, for example, a polyester resin having an epoxy group, or the like. The polyester resin preferably includes two or more epoxy groups in a single molecule.

As the epoxy resin, other than the epoxy resins (1) to (7), epoxy resins (8) to (11) shown in the following may be used.

The epoxy resin (8) includes, for example: a compound obtained by modifying, through epoxidation, a carbon-carbon double bond of a (co)polymer having a conjugated diene compound as a main body thereof; a compound obtained by modifying, through epoxidation, a carbon-carbon double bond of a partially hydrogenated compound of a (co)polymer having a conjugated diene compound as a main body thereof; or the like. Specific examples of the epoxy resin (8) include a polybutadiene modified by epoxidation, a dicyclopentadiene modified by epoxidation, or the like.

The epoxy resin (9) includes: a compound obtained by modifying, through epoxidation, a carbon-carbon double bond of a block copolymer including, in the same molecule, a polymeric block having a vinyl aromatic compound as a main body thereof, and a polymeric block having a conjugated diene compound as a main body thereof or a partially hydrogenated compound of the polymeric block; or the like. Examples of such compounds include SBS modified by epoxidation or the like.

The epoxy resin (10) includes, for example, a urethane modified epoxy resin obtained by introducing a urethane bond in the structures of the epoxy resins of (1) to (9), or a polycaprolactone modified epoxy resin obtained by introducing a polycaprolactone bond in the structures of the epoxy resins of (1) to (9).

The epoxy resin (11) includes an epoxy resin or the like having a bisaryl fluorene backbone.

Commercial items of the epoxy resin (11) include, for example, “On-coat EX series”, which is a product name and which is manufactured by Osaka Gas Chemicals Co., Ltd., or the like.

Furthermore, a flexible epoxy resin may be suitably used as the epoxy resin. Using the flexible epoxy resin can increase flexibility of the cured body.

The flexible epoxy resin includes: a diglycidyl ether of polyethylene glycol; a diglycidyl ether of polypropylene glycol; a poly glycidyl ether of a long chain polyol; a copolymer of glycidyl(meth)acrylate and a radical polymerizable monomer; a polyester resin including epoxy group; a compound obtained by modifying, through epoxidation, a carbon-carbon double bond of a (co)polymer having a conjugated diene compound as a main body thereof; a compound obtained by modifying, through epoxidation, a carbon-carbon double bond of a partially hydrogenated compound of a (co)polymer having a conjugated diene compound as a main body thereof; a urethane modified epoxy resin; a polycaprolactone modified epoxy resin; or the like.

Furthermore, the flexible epoxy resin includes a dimer acid modified epoxy resin obtained by introducing an epoxy group within a molecule of a dimer acid or a derivative of a dimer acid, a rubber modified epoxy resin obtained by introducing an epoxy group within a molecule of a rubber ingredient, or the like.

The rubber ingredient includes NBR, CTBN, polybutadiene, acrylic rubber, or the like.

The flexible epoxy resin preferably has a butadiene backbone. By using the flexible epoxy resin having a butadiene backbone, flexibility of the cured body can be further increased. In addition, the rate of elongation of the cured body can be increased in a broad temperature range from a low temperature range to a high temperature range.

As the epoxy resin, a biphenyl type epoxy resin, a naphthalene type epoxy resin, an anthracene type epoxy resin, an adamantane type epoxy resin, and a trivalent epoxy resin having a triazine nucleus in a backbone thereof may be used. The biphenyl type epoxy resin includes a compound or the like obtained by substituting a part of hydroxyl groups of a phenolic compound with groups containing an epoxy group, and by substituting the remaining hydroxyl groups with substituent groups other than hydroxyl group such as hydrogen. By using these epoxy resins, the linear expansion coefficient of the cured body can be effectively reduced.

The biphenyl type epoxy resin is preferably a biphenyl type epoxy resin represented by the following formula (8). By using this preferable biphenyl type epoxy resin, the linear expansion coefficient of the cured body can be further reduced.

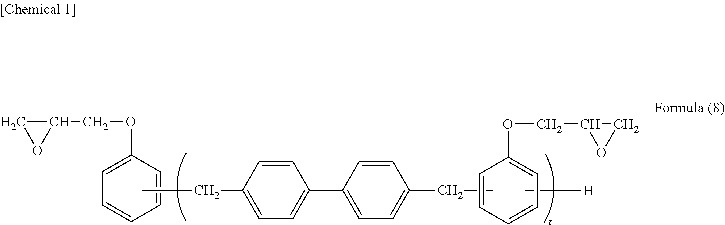

In the formula (8), t indicates an integer of 1 to 11.

(Curing Agent)

The curing agent included in the epoxy resin composition according to the present invention is not particularly limited as long as it can cure an epoxy resin. A conventionally well-known curing agent may be used as the curing agent.

The curing agent includes, for example, dicyandiamide, an amine compound, a compound synthesized from an amine compound, a hydrazide compound, a melamine compound, an acid anhydride, a phenolic compound, an active ester compound, a benzoxazine compound, a maleimide compound, a heat latent cationic polymerization catalyst, a light latent cationic polymerization initiator, a cyanate ester resin, or the like. Derivatives of these curing agents may be used. With regard to the curing agent, a single type may be used by itself, or a combination of two or more types may be used. Furthermore, a curing catalyst such as iron acetylacetone may be used together with the curing agent.

The amine compound includes, for example, a linear aliphatic amine compound, a cyclic aliphatic amine compound, an aromatic amine compound, or the like.

The linear aliphatic amine compound includes, for example, ethylene diamine, diethylene triamine, triethylene tetramine, tetraethylene pentamine, polyoxypropylene diamine, polyoxypropylene triamine, or the like.

The cyclic aliphatic amine compound includes, for example, menthene diamine, isophorone diamine, bis(4-amino-3-methylcyclohexyl)methane, diaminodicyclohexylmethane, bis(aminomethyl)cyclohexane, N-aminoethyl piperazine, 3,9-bis(3-aminopropyl)-2,4,8,10-tetraoxaspiro(5,5)undecane, or the like.

The aromatic amine compound includes, for example, m-xylenediamine, α-(m/p-aminophenyl)ethylamine, m-phenylenediamine, diaminodiphenylmethane, diaminodiphenylsulfone, α,α-bis(4-aminophenyl)-p-diisopropylbenzene, or the like.

A tertiary amine compound may be used as the amine compound. The tertiary amine compound includes, for example, N,N-dimethylpiperazine, pyridine, picoline, benzyldimethylamine, 2-(dimethylamino methyl)phenol, 2,4,6-tris(dimethylamino methyl)phenol, 1,8-diazabiscyclo(5,4,0)undecene-1, or the like.

Specific examples of the compound synthesized from the amine compound include a polyamino-amide compound, a polyamino-imide compound, a ketimine compound, or the like.

The polyamino-amide compound includes, for example, a compound synthesized from the amine compound and a carboxylic acid, or the like. The carboxylic acid includes, for example, succinic acid, adipic acid, azelaic acid, sebacic acid, dodecanedioic acid, isophthalic acid, terephthalic acid, dihydroisophthalic acid, tetrahydroisophthalic acid, hexahydroisophthalic acid, or the like.

The polyamino-imide compound includes, for example, a compound synthesized from the amine compound and a maleimide compound, or the like. The maleimide compound includes, for example, diaminodiphenylmethane bismaleimide or the like.

Furthermore, the ketimine compound includes, for example, a compound synthesized from the amine compound and a ketone compound, or the like.

Other specific examples of the compound synthesized from the amine compound include a compound synthesized from the amine compound, and an epoxy compound, a urea compound, a thiourea compound, an aldehyde compound, a phenolic compound, or an acrylic based compound.

The hydrazide compound includes, for example, 1,3-bis(hydrazinocarboethyl)-5-isopropylhydantoin, 7,11-octadecadiene-1,18-dicarbohydrazide, eicosanedioic acid dihydrazide, adipic acid dihydrazide, or the like.

The melamine compound includes, for example, 2,4-diamino-6-vinyl-1,35-triazine, or the like.

The acid anhydride includes, for example, phthalic anhydride, trimellitic anhydride, pyromellitic anhydride, benzophenone tetracarboxylic anhydride, ethylene glycol bisanhydro trimellitate, glycerol trisanhydro trimellitate, methyl tetrahydrophthalic anhydride, tetrahydrophthalic anhydride, nadic anhydride, methyl nadic anhydride, trialkyl tetrahydrophthalic anhydride, hexahydrophthalic anhydride, methyl hexahydrophthalic anhydride, 5-(2,5-dioxotetrahydro furil)-3-methyl-3-cyclohexene-1,2-dicarboxylic anhydride, an adduct of trialkyl tetrahydrophthalic anhydride-maleic anhydride, dodecenyl succinic anhydride, polyazelaic anhydride, polydodecanedioic anhydride, chlorendic anhydride, or the like.

The heat latent cationic polymerization catalyst includes, for example, an ionic heat latent cationic polymerization catalyst, or a nonionic heat latent cationic polymerization catalyst.

The ionic heat latent cationic polymerization catalyst includes a benzylsulfonium salt, a benzylammonium salt, a benzylpyridinium salt, a benzylsulfonium salt, or the like having, as a counter-anion, antimony hexafluoride, phosphorus hexafluoride, boron tetrafluoride, or the like.

The nonionic heat latent cationic polymerization catalyst includes N-benzyl phthalimide, an aromatic sulphonic acid ester, or the like.

The light latent cationic polymerization catalyst includes, for example, an ionic light latent cationic polymerization initiator, or a nonionic light latent cationic polymerization initiator.

Specific examples of the ionic light latent cationic polymerization initiator include onium salts, organometallic complexes, or the like. The onium salts include, for example, an aromatic diazonium salt, an aromatic halonium salt, an aromatic sulfonium salt, or the like having, as a counter-anion, antimony hexafluoride, phosphorus hexafluoride, boron tetrafluoride, or the like. The organometallic complexes include, for example, an iron-allene complex, a titanocene complex, an aryl silanol-aluminium complex, or the like.

Specific examples of the nonionic light latent cationic polymerization initiator include a nitrobenzyl ester, a sulfonic acid derivative, a phosphate ester, a phenolsulfonic acid ester, diazonaphthoquinone, N-hydroxyimide sulfonate, or the like.

The phenolic compound includes, for example, a phenol novolac, an o-cresol novolac, a p-cresol novolac, a t-butyl phenol novolac, dicyclopentadiene cresol, a phenol aralkyl resin, an α-naphthol aralkyl resin, a β-naphthol aralkyl resin, an amino triazine novolac resin, or the like. Derivatives of these may be used as the phenolic compound. With regard to the phenolic compound, a single type may be used by itself, or a combination of two or more types may be used.

The phenolic compound may be suitably used as the curing agent. By using the phenolic compound, the heat resistance and the dimensional stability of the cured body can be increased, and water absorptivity of the cured body can also be reduced. Furthermore, the surface roughness of the surface of the cured body obtained by performing a roughening treatment can be further reduced. Specifically, the arithmetic mean roughness Ra and the ten-point mean roughness Rz of the surface of the roughening-treated cured body can be further reduced.

A phenolic compound represented by any one of the following formula (1), formula (2), or formula (3) is more suitably used as the curing agent. In this case, the surface roughness of the surface of the cured body can be further reduced.

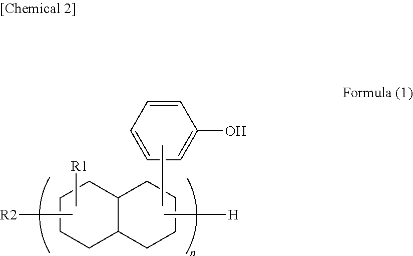

In the above described formula (1), R1 represents a methyl group or an ethyl group, R2 represents a hydrogen or a hydrocarbon group, and n represents an integer of 2 to 4.

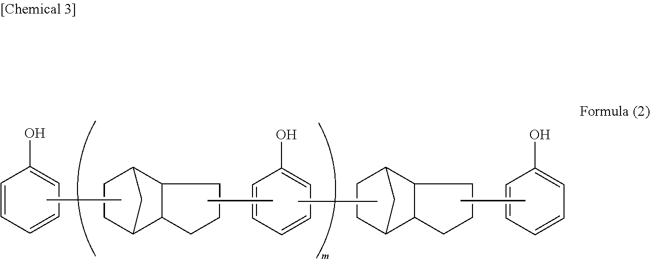

In the above described formula (2), m represents an integer of 0 to 5.

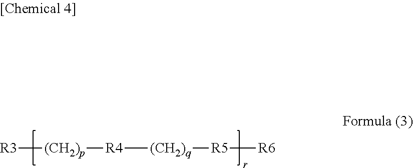

In the above described formula (3), R3 indicates a group represented by the following formula (4a) or formula (4b), R4 indicates a group represented by the following formula (5a), formula (5b), or formula (5c), R5 indicates a group represented by the following formula (6a) or formula (6b), R6 indicates a hydrogen or an organic group having a carbon number of 1 to 20, p represents an integer of 1 to 6, q represents an integer of 1 to 6, and r represents an integer of 1 to 11.

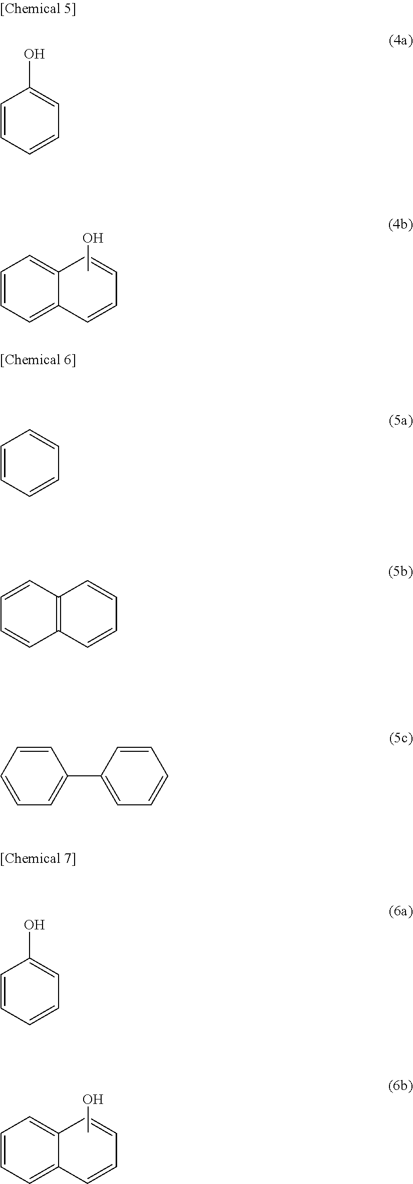

Among those, the phenolic compound having a biphenyl Structure, which is a phenolic compound represented by the formula (3) and in which R4 in the formula (3) is a group represented by the formula (5c), is preferable. By using this preferable curing agent, the electrical property and the heat resistance of the cured body can be further increased, and the linear expansion coefficient and water absorptivity of the cured body can be further reduced. Furthermore, in case a thermal history is to be given to the cured body, the dimensional stability thereof can be further increased.

A phenolic compound having the structure shown in the following formula (7) is particularly preferable as the curing agent. In this case, the electrical property and the heat resistance of the cured body can be further increased, and the linear expansion coefficient and water absorptivity of the cured body can be further reduced. Furthermore, in case a thermal history is to be given to the cured body, the dimensional stability thereof can be further increased.

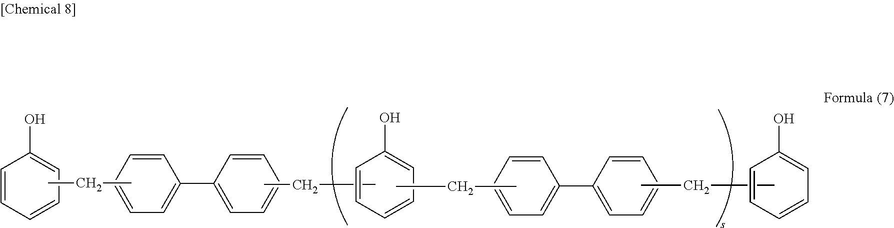

In the above described formula (7), s represents an integer of 1 to 11.

The active ester compound includes, for example, an aromatic multivalent ester compound or the like. When an active ester compound is used, a cured body having excellent dielectric constant and dielectric loss tangent can be obtained, since an OH group is not generated at the time of a reaction between the active ester group and the epoxy resin. Specific examples of the active ester compound are disclosed in, for example, Japanese Laid-Open Patent Publication No. 2002-12650.

Commercial items of the active ester compound include, for example, “EPICLON EXB9451-65T” and “EPICLON EXB9460S-65T”, which are product names and which are manufactured by DIC Corp., and the like.

The benzoxazine compound includes an aliphatic benzoxazine resin or an aromatic benzoxazine resin.

Commercial items of the benzoxazine compound include, for example, “P-d type benzoxazine” and “F-a type benzoxazine”, which are product names and which are manufactured by Shikoku Chemicals Corp., and the like.

For example, a novolac type cyanate ester resin, a bisphenol type cyanate ester resin, a prepolymer having one part thereof modified to have a triazine structure, and the like can be used as the cyanate ester resin. By using the cyanate ester resin, the linear expansion coefficient of the cured body can be further reduced.

The maleimide compound is preferably at least one type selected from the group consisting of N,N′-4,4-diphenylmethane bismaleimide, N,N′-1,3-phenylene dimaleimide, N,N′-1,4-phenylene dimaleimide, 1,2-bis(maleimide) ethane, 1,6-bismaleimide hexane, bis(3-ethyl-5-methyl-4-maleimide phenyl)methane, polyphenylmethane maleimide, bisphenol A diphenyl ether bismaleimide, 4-methyl-1,3-phenylene bismaleimide, 1,6-bismaleimide-(2,2,4-trimethyl) hexane, oligomers of these, and maleimide-backbone-containing diamine condensates. By using these preferable maleimide compounds, the linear expansion coefficient of the cured body can be further reduced, and the glass transition temperature of the cured body can be further increased. The above described oligomer is an oligomer obtained by condensating a maleimide compound which is a monomer among the above described maleimide compounds.

Among those, the maleimide compound is more preferably at least one of polyphenylmethane maleimide or a bismaleimide oligomer. The bismaleimide oligomer is preferably an oligomer obtained by condensating phenylmethane bismaleimide and 4,4-diaminodiphenylmethane. By using these preferably maleimide compounds, the linear expansion coefficient of the cured body can be further reduced, and the glass transition temperature of the cured body can be further increased.

Commercial items of the maleimide compound include polyphenylmethane maleimide (product name “BMI-2300” manufactured by Daiwa Fine Chemicals Co., Ltd.), a bismaleimide oligomer (product name “DAIMAID-100H” manufactured by Daiwa Fine Chemicals Co., Ltd.), and the like.

BMI-2300 manufactured by Daiwa Fine Chemicals Co., Ltd. is a low molecular weight oligomer. DAIMAID-100H manufactured by Daiwa Fine Chemicals Co., Ltd. is a condensate obtained by using diaminodiphenylmethane as an amine curing agent, and has a high molecular weight. If DAIMAID-100H is used instead of BMI-2300, the breaking strength and the breaking point elongation rate of the cured body can be increased. However, when compared to a case of using BMI-2300 described above, the use of DAIMAID-100H can result in a reduced linear expansion coefficient of the cured body.

The curing agent is preferably at least one type selected from the group consisting of phenolic compounds, active ester compounds, and benzoxazine compounds. By using these preferable curing agents, the resin component is not likely to be subjected to adverse influences during a roughening treatment.

When the active ester compound or the benzoxazine compound is used as the curing agent, a cured body having even better dielectric constant and dielectric loss tangent can be obtained. The active ester compound is preferably an aromatic multivalent ester compound. By using the aromatic multivalent ester compound, a cured body having even better dielectric constant and dielectric loss tangent can be obtained.

When the active ester compound is used as the curing agent, advantageous effects such as even better dielectric constant and dielectric loss tangent, and a superior fine-wiring formability are obtained. Therefore, for example, when the epoxy resin composition is used as an insulator for build-ups, an advantageous effect of having a superior signal transmission particularly in a high frequency range can be expected.

With regard to the curing agent, the phenolic compound is preferably at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins. By using these preferable curing agents, the resin component is even more unlikely to be subjected to adverse influences during a roughening treatment. Specifically, during a roughening treatment, fine holes can be formed without excessively roughening the surface of the cured body by selectively eliminating the silica component. Thus, fine concavities and convexities with a very small surface roughness can be formed on the surface of the cured body. Among the above, the phenolic compounds having a biphenyl structure are preferable.

A cured body having a superior electrical property, in particular, having a superior dielectric loss tangent, and also having a superior strength and linear expansion coefficient, and additionally having a low water absorption rate, can be obtained by using a phenolic compound having a biphenyl structure, a phenolic compound having a naphthalene structure, or a cyanate ester resin.

If the molecular weights of the epoxy resin and the curing agent are high, it becomes easy to form a fine rough-surface on the surface of the cured body. The weight average molecular weight of the epoxy resin influences formation of a fine rough-surface. However, the weight average molecular weight of the curing agent has a larger influence on the formation of a fine rough-surface than the weight average molecular weight of the epoxy resin. The weight average molecular weight of the curing agent is preferably equal to or higher than 500, and more preferably equal to or higher than 1800. A preferable upper limit of the weight average molecular weight of the curing agent is 15000. If the weight average molecular weight of the curing agent is too high, due to a swelling treatment and a roughening treatment conducted thereon, there are cases where it becomes difficult to perform etching on the resin, and there are cases where the resin cannot be sufficiently removed during a laser hole boring process.

If the epoxy equivalent of the epoxy resin and the equivalent amount of the curing agent are large, it becomes easy to form a fine rough-surface on the surface of the cured body. Furthermore, it becomes easy to form a fine rough-surface on the surface of the cured body if the curing agent is a solid, and if the softening temperature of the curing agent is equal to or higher than 60° C.

It is preferable to include the curing agent within a range between 1 to 200 parts by weight with regard to 100 parts by weight of the epoxy resin. If the curing agent content is too low, the epoxy resin may not be cured sufficiently. If the curing agent content is too high, the effect of curing the epoxy resin may reach saturation. With regard to the curing agent content, a more preferable lower limit is 30 parts by weight, and a more preferable upper limit is 140 parts by weight.

(Curing Accelerator)

The epoxy resin composition according to the present invention preferably includes a curing accelerator. In the present invention, the curing accelerator is an optional component. There is no particular limitation in the curing accelerator used in the present invention.

The curing accelerator is preferably an imidazole compound. The curing accelerator is preferably at least one type selected from the group consisting of 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2,4-diamino-6-[2′-methyl imidazolyl-(1′)]ethyl-s-triazine, 2,4-diamino-6-[2′-undecyl imidazolyl-(1′)]ethyl-s-triazine, 2,4-diamino-6-[2′-ethyl-4′-methyl imidazolyl-(1′)]-ethyl-s-triazine, adducts of 2,4-diamino-6-[2′-methyl imidazolyl-(1′)]ethyl-s-triazine isocyanuric acid, adducts of 2-phenyl imidazole isocyanuric acid, adducts of 2-methyl imidazole isocyanuric acid, 2-phenyl-4,5-dihydroxymethylimidazole, and 2-phenyl-4-methyl-5-dihydroxymethylimidazole.

Furthermore, the curing accelerator includes a phosphine compound such as triphenyl phosphine, diazabicycloundecene (DBU), diazabicyclononene (DBN), a phenol salt of DBU, a phenol salt of DBN, an octylic acid salt, a p-toluenesulfonic acid salt, a formate, an orthophthalate, a phenol novolac resin salt, or the like.

The curing accelerator is included within a range between 0 to 3.5 parts by weight with regard to a total of 100 parts by weight of the epoxy resin and the curing agent. In other words, the epoxy resin composition according to the present invention does not include the curing accelerator, or when the curing accelerator is included, 3.5 parts by weight or less of the curing accelerator is included with regard to a total of 100 parts by weight of the epoxy resin and the curing agent.

With the present invention, even when the curing accelerator is not added, the surface roughness can be reduced for the surface of the cured body obtained by performing a roughening treatment. However, when the curing accelerator is not added, there are cases where Tg becomes low without a sufficient progress in the curing of the epoxy resin composition, and where the strength of the cured body fails to become sufficiently high. Therefore, it is more preferable to include the curing accelerator in the epoxy resin composition according to the present invention.

With regard to the curing accelerator content, a preferable lower limit is 0.001 parts by weight, and a more preferable lower limit is 0.01 parts by weight, and an even more preferable lower limit is 0.5 parts by weight. If the curing accelerator content is too low, the epoxy resin may not be cured sufficiently.

If the curing accelerator content is too high, even if the resin composition is cured, the molecular weight may not be sufficiently high, and crosslinks in the epoxy resin may become inhomogeneous, since there will be many reaction starting points. Additionally, there is also a problem where preservation stability of the epoxy resin composition becomes inferior.

The mechanism is not clear, but the surface roughness tends to become large for the surface of the roughening-treated cured body if the curing accelerator content is high. Thus, an upper limit of the curing accelerator content is 3.5 parts by weight, and preferably, the upper limit is 1.5 parts by weight.

(Silica Component)

The epoxy resin composition of the present invention includes a silica component obtained by facing silica particles with a silane coupling agent. With regard to the silica component, a single type may be used by itself, or a combination of two or more types may be used.

The mean particle diameter of the silica particles is equal to or less than 1 μm. By having the mean particle diameter to be equal to or less than 1 μm, a fine rough-surface can be formed on the cured body obtained by performing a roughening treatment. Furthermore, fine holes having a size in which the mean diameter is equal to or less than 1 μm can be formed on the surface of the cured object. A lower limit of the mean particle diameter of the silica particles is preferably 100 nm, and the lower limit is more preferably 300 nm, and the upper limit is more preferably 500 nm.

If the mean particle diameter of the silica particles is too large, it becomes difficult to eliminate the silica component during a roughening treatment. Furthermore, if plate processing is conducted in order to form a metal layer on the surface of the roughening-treated cured body, a plating may slip into a void between the resin component and a silica component that has not been eliminated. Therefore, if the metal layer is a circuit, a defect may occur in the circuit.

In particular, when a phenolic compound having a biphenyl structure, an active ester compound, or a benzoxazine compound is used as the curing agent, it is difficult to remove the resin component from the periphery of the silica component by a roughening treatment. In this case, if the mean particle diameter of the silica particles is larger than 1 μm, a post-roughened adhesive strength tends to become low since elimination of the silica component is more difficult.

In the present invention, the amount B (g) of the silane coupling agent used for surface treatment, per 1 g of the silica particles in the silica component, is within a range between 10% to 80% with regard to a value C (g) per 1 g of the silica particles, which is calculated by the following formula (X). Thus, the silica component used in the present invention is obtained by performing a surface treatment on the silica particles by using the silane coupling agent such that the amount B (g) of the silane coupling agent used for surface treatment, per 1 g of the silica particles, is within a range between 10% to 80% with regard to the value C (g) per 1 g of the silica particles. The value C per 1 g of the silica particles is sometimes referred to as, for example, a theoretical amount of addition of the silane coupling agent per 1 g of the silica particles.

C (g)/1 g of Silica Particles=[Specific Surface Area of Silica Particles (m²/g)/Minimum Area Coated by Silane Coupling Agent (m²/g)] Formula (X)

In addition, a minimum coated area of the silane coupling agent can be obtained from the following formula (Y).

Minimum Coated Area (m²/g)=6.02×10²³×13×10⁻²⁰/Molecular Weight of Silane Coupling Agent Formula (Y)

Even when the mean particle diameter is equal to or less than 1 μm, if silica particles which is obtained without being surface-treated with the silane coupling agent is used, the silica particles tend to aggregate.

Conversely, in the present invention, since silica particles having a mean particle diameter equal to or less than 1 μm are included in the silica component obtained by performing a surface treatment using the specific amount of the silane coupling agent, the silica components will hardly aggregate. Therefore, the dispersibility of the silica component in the epoxy resin composition can be increased.

The mechanism is not clear, but interface adherence between the silica component and the resin becomes insufficient if the amount used for surface treatment is too small. Therefore, the resin is easily removed by a roughening treatment, and the surface roughness of the surface of the cured body tends to become large. Furthermore, if the amount used for surface treatment is too large, interface adherence between the resin and the silica component tends to become too high due to the silane coupling agent. Thus, the resin becomes difficult to remove by a roughening treatment, and the post-roughened adhesive strength becomes low. It has been discovered for the first time with the present invention that by designing the amount of the silane coupling agent used for surface treatment in an appropriate range, the surface roughness of the surface of the cured body after a roughening treatment can be reduced, and thereby a cured body suited for forming fine wirings can be obtained. Furthermore, it is possible to obtain a cured body having a high post-roughened adhesive strength, even though the surface roughness of the surface of the cured body after a roughening treatment is very small, since the interface adherence between the silica component and the resin is designed to be in an optimal range in the present invention. Thus, when a metal layer is formed on the surface of the cured body obtained by performing a roughening treatment, the adhesive strength between the cured body and the metal layer can be increased.

If the amount B (g) of the silane coupling agent used for surface treatment, per 1 g of the silica particles, is smaller than 10% with regard to the value C (g) per 1 g of the silica particles, the surface roughness becomes large for the surface of the cured body obtained by performing a roughening treatment on the surface of the cured object. The mechanism is not clear, but it is presumably because interface adherence between the silica component and the resin cannot be obtained since a small area coated is by the silane coupling agent, causing silica to be easily eliminated and removed during a roughening treatment resulting in an increase of the surface roughness. If the area coated by the silane coupling agent is small, water absorptivity of the cured body reduces, and a possibility of having a problem in insulation reliability is also conceivable.

If the amount B (g) of the silane coupling agent used for surface treatment, per 1 g of the silica particles, is larger than 80% with regard to the value C (g) per 1 g of the silica particles, the post-roughened adhesive strength becomes small. In a roughening treatment, by removing the resin component on the surface of a preliminary-cured body, the silica component on the surface is exposed to a certain degree, and adhesion interface between the silica component and the resin component can disappear. With this, a rough surface is formed by eliminating the silica component.

The mechanism is not clear, but it is presumably because, when the area coated by the silane coupling agent is too large, interface adherence between the silica particles and the resin becomes high, and if a roughening treatment is conducted to a degree such that the silica component will be eliminated, a degradation of the resin component progresses into a portion deeper than the outer layer of the resin component, and thereby reducing the post-roughened adhesive strength.

With regard to the mean particle diameter of the silica particles, a value of median diameter (d50) representing 50% can be used. The mean particle diameter can be measured by using a particle-size-distribution measuring device utilizing laser diffraction dispersion method.

A plurality of types of silica particles having different mean particle diameters may be used. When considering close-packing, it is preferable to use the plurality of types of silica particles having different particle size distributions. In this case, the epoxy resin composition can be suitably used, for example, in a usage requiring fluidity such as for a parts-built-in substrate. Furthermore, apart from the silica component, by using silica particles having a mean particle diameter of several tens of nanometers, the viscosity of the epoxy resin composition can be increased and the thixotropism of the epoxy resin composition can be controlled.

The maximum particle diameter of the silica particles is preferably equal to or less than 5 μm. If the maximum particle diameter is equal to or less than 5 μm, the silica component can be more easily eliminated during a roughening treatment. Furthermore, a relatively large hole is unlikely to be generated on the surface of the cured body, and thereby homogeneous and fine concavities and convexities can be formed.

In particular, when a phenolic compound having a biphenyl structure, an active ester compound, or a benzoxazine compound is used as the curing agent, it is difficult for a roughening liquid to penetrate into a preliminary-cured object from the surface of the preliminary-cured object, thus it becomes relatively difficult to eliminate the silica component. However, by using the silica component having a maximum particle diameter equal to or less than 5 μm, the silica component can be effortlessly eliminated. When forming fine wirings having an L/S equal to or less than 15 μm/15 μm on the surface of the cured body, insulation reliability can be increased; and therefore the maximum particle diameter of the silica particles is preferably equal to or less than 2 μm. Note that “L/S” represents: a wiring width-direction dimension (L)/a dimension (S) in a width direction of a portion on which wirings are not formed.

There is no particular limitation in the shape of the silica particles. Examples of the shape of the silica particles include a spherical shape, an unfixed shape, or the like. It is preferable to have the silica particles to be spherical, and more preferable to be true-spherical, since the silica component can be more easily eliminated during a roughening treatment.

The specific surface area of the silica particles is preferably equal to or larger than 3 m²/g. If the specific surface area is smaller than 3 m²/g, the mechanical property of the cured body may deteriorate. Thus, for example, adhesiveness between the metal layer and the cured body obtained by performing a roughening treatment may deteriorate. The specific surface area can be obtained from the BET method.

The silica particles includes, a crystalline silica obtained by grinding a natural silica material, a crushed-fused silica obtained by flame-fusing and grinding a natural silica material, a spherical fused silica obtained by flame-fusing, grinding, and then flame-fusing a natural silica material, a fumed silica (aerosil), a synthetic silica such as a sol-gel processed silica, or the like.

The synthetic silica often includes ionic impurities. A fused silica is suitably used since purity thereof is high. The silica particles may be used as a silica slurry in a state of being dispersed in a solvent. The use of the silica slurry can increase workability and productivity during manufacturing of the epoxy resin composition.

A general silane compound can be used as the silane coupling agent. At least one type selected from the group consisting of epoxy silanes, amino silanes, isocyanate silanes, acryloxy silanes, methacryloxy silanes, vinyl silanes, styryl silanes, ureido silanes, sulfide silanes, and imidazole silanes can be used as the silane coupling agent. Furthermore, a surface treatment of the silica particles may be conducted by using an alkoxy silane such as a silazane. With regard to the silane coupling agent, a single type may be used by itself, or a combination of two or more types may be used.

The silica component may be added to the resin composition after the silica component is obtained by surface-treating the silica particles by using the silane coupling agent. Alternatively, the resin composition may be mixed after adding the silica particles and the silane coupling agent to the resin composition. As a result of the mixing of the resin composition, the silica particles are surface-treated by the silane coupling agent.

It is preferable to add the silica component to the resin composition after the silica component is obtained by surface-treating the silica particles by using the silane coupling agent. With this, the dispersibility of the silica component can be further increased.

A method for surface-treating the silica particles by using the silane coupling agent includes the following first to third methods, for example.

A dry method can be listed as the first method. The dry method includes, for example, a method of directly adhering the silane coupling agent to the silica particles, or the like. In the dry method, the silica particles are loaded in a mixer, and while agitating the silica particles, an alcohol solution or an aqueous solution of the silane coupling agent is dropped or sprayed therein. The mixture is further agitated and sorted using a sieve. Then, the silica component is obtained by dehydration condensation of the silane coupling agent and the silica particles through heating. The obtained silica component may be used as a silica slurry in a state of being dispersed in a solvent.

A wet method can be listed as the second method. In the wet method, the silane coupling agent is added to a silica slurry containing the silica particles while agitating the silica slurry. After agitating, the mixture is filtrated, dried, and sorted using a sieve. Then, the silica component is obtained by dehydration condensation of the silane compound and the silica through heating.

As the third method, a method of adding the silane coupling agent while agitating a silica slurry containing the silica particles; and advancing dehydration condensation by heat reflux processing, can be listed. The obtained silica component may be used as a silica slurry in a state of being dispersed in a solvent.

If untreated silica particles are used, the silica particles and the epoxy resin will not form a composite even when the epoxy resin composition is cured. A composite of the silica component and the epoxy resin is obtained when the epoxy resin composition is cured by using the silica component obtained by performing a surface treatment on the silica particles using the above described specific amount of the silane coupling agent. As a result, the glass transition temperature Tg of the cured object becomes high. Therefore, by including, in the epoxy resin composition, the silica component obtained by performing a surface treatment on the silica particles using the silane coupling agent instead of untreated silica particles, the glass transition temperature Tg of the cured body can be increased.

The silica component is preferably included within a range between 10 to 400 parts by weight with regard to a total of 100 parts by weight of the epoxy resin and the curing agent. With regard to a total of 100 parts by weight of the epoxy resin and the curing agent, a more preferable lower limit of the silica component content is 25 parts by weight, and an even more preferable lower limit is 43 parts by weight, and a more preferable upper limit is 250 parts by weight, and an even more preferable upper limit is 150 parts by weight. If the silica component content is too low, a total surface area of holes formed as a result of the elimination of the silica component during a roughening treatment becomes small. Therefore, the adhesive strength between the roughening-treated cured body and the metal layer may not be sufficiently increased. If the silica component content is too high, the roughening-treated cured body tends to be fragile, and the adhesive strength between the cured body and the metal layer may decrease.

(Organically Modified Sheet Silicate)

The epoxy resin composition according to the present invention preferably includes an organically modified sheet silicate.

In an epoxy resin composition including the organically modified sheet silicate, the organically modified sheet silicate exists in surrounding areas of the silica component. Therefore, the silica component existing on the surface of the preliminary-cured object is more easily eliminated during a swelling treatment and a roughening treatment. This is presumed to be because the swelling liquid or roughening liquid also penetrates interfaces between the epoxy resin and the silica component, in addition to the swelling liquid or roughening liquid penetrating a countless number of nano scale interfaces between layers of the organically modified sheet silicate or between the organically modified sheet silicate and the resin component. However, the mechanism of how the silica component becomes easily eliminated is not clear.

The organically modified sheet silicate includes, for example, organically modified sheet silicates obtained by organically modifying sheet silicates such as a smectite based clay mineral, a swelling mica, vermiculite, or halloysite. With regard to the organically modified sheet silicate, a single type may be used by itself, or a combination of two or more types may be used.

The smectite based clay mineral includes montmorillonite, hectorite, saponite, beidellite, stevensite, nontronite, or the like.

As the organically modified sheet silicate, an organically modified sheet silicate obtained by organically modifying at least one type of sheet silicate selected from the group consisting of montmorillonite, hectorite, and swelling mica may be suitably used.

The mean particle diameter of the organically modified sheet silicate is preferably equal to or less than 500 nm. With this, the dispersibility of the organically modified sheet silicate within the epoxy resin composition can be increased.

With regard to the mean particle diameter of the organically modified sheet silicate, a value of median diameter (d50) representing 50% can be used. The mean particle diameter can be measured by using a particle-size-distribution measuring device utilizing laser diffraction dispersion method.

The organically modified sheet silicate is preferably included within a range between 0.01 to 3 parts by weight with regard to a total of 100 parts by weight of the epoxy resin and the curing agent. If the organically modified sheet silicate content is too low, an effect of easily eliminating the silica component can become insufficient. If the organically modified sheet silicate content is too high, the number of interfaces to be penetrated by the swelling liquid or roughening liquid becomes too large, and thereby the surface roughness of the surface of the cured body obtained by performing a roughening treatment tends to be relatively large. Particularly when the epoxy resin composition is used as a sealing agent, if the organically modified sheet silicate content becomes too high, since a penetration speed of the swelling liquid or the roughening liquid becomes faster, a speed at which the surface roughness of the surface of the cured body will change by a roughening treatment becomes too high, which may lead to cases where treatment time for a swelling treatment or a roughening treatment cannot be sufficiently ensured.

When the organically modified sheet silicate is not used, the surface roughness of the surface of the cured body obtained by performing a roughening treatment becomes even smaller. By adjusting a blend ratio of the silica component and the organically modified sheet silicate, the surface roughness of the roughening-treated cured object can be controlled.

(Other Components that can be Added)

The epoxy resin composition according to the present invention preferably includes an imidazole silane compound. By using the imidazole silane compound, the surface roughness of the surface of the roughening-treated cured body can be further reduced.

The imidazole silane compound is preferably included within a range between 0.01 to 3 parts by weight with regard to a total of 100 parts by weight of the epoxy resin and the curing agent. If the imidazole silane compound content is within the above described range, the surface roughness of the surface of the roughening-treated cured body can be further reduced, and the post-roughened adhesive strength between the cured body and the metal layer can be further increased. A more preferable lower limit of the imidazole silane compound content is 0.03 parts by weight, and a more preferable upper limit is 2 parts by weight, and an even more preferable upper limit is 1 part by weight. When the curing agent content is higher than 30 parts by weight to 100 parts by weight of the epoxy resin, it is particularly preferably to include the imidazole silane compound within a range between 0.01 to 2 parts by weight with regard to a total of 100 parts by weight of the epoxy resin and the curing agent.

In addition to the epoxy resin, if necessary, the epoxy resin composition according to the present invention may include a resin that is copolymerizable with the epoxy resin.

There is no particular limitation in the copolymerizable resin. The copolymerizable resin includes, for example, a phenoxy resin, a thermosetting modified-polyphenylene ether resin, a benzoxazine resin, or the like. With regard to the copolymerizable resin, a single type may be used by itself, or a combination of two or more types may be used.

Specific examples of the thermosetting modified-polyphenylene ether resin include resins or the like obtained by modifying a polyphenylene ether resin using functional groups such as epoxy group, isocyanate group, or amino group. With regard to the thermosetting modified-polyphenylene ether resin, a single type may be used by itself, or a combination of two or more types may be used.

Commercial items of the cured-type modified-polyphenylene ether resin obtained by modifying a polyphenylene ether resin using epoxy group include, for example, “OPE-2Gly”, which is a product name and which is manufactured by Mitsubishi Gas Chemical Co., Inc., or the like.

There is no particular limitation in the benzoxazine resin. Specific examples of the benzoxazine resin include: a resin in which a substituent group having a backbone of an aryl group such as methyl group, ethyl group, phenyl group, biphenyl group, or cyclohexyl group, is coupled to the nitrogen of an oxazine ring; a resin in which a substituent group having a backbone of an allylene group such as methylene group, ethylene group, phenylene group, biphenylene group, naphthalene group, or cyclohexylene group, is coupled in between the nitrogen atoms of two oxazine rings; or the like. With regard to the benzoxazine resin, a single type may be used by itself, or a combination of two or more types may be used. As a result of a reaction between the benzoxazine resin and the epoxy resin, the heat resistance of the cured object can be enhanced, and water absorptivity and the linear expansion coefficient can be reduced.

Note that, monomer or oligomer of benzoxazine, or a resin obtained by being given a high molecular weight by conducting a ring opening polymerization of the oxazine ring of monomer or oligomer of benzoxazine, is included in the benzoxazine resin.

To the epoxy resin composition according to the present invention, additives such as thermoplastic resins, thermosetting resins other than the epoxy resin, thermoplastic elastomers, crosslinked rubbers, oligomers, inorganic compounds, nucleating agents, antioxidants, antistaling agents, thermostabilizers, light stabilizers, ultraviolet ray absorbing agents, lubricants, flame-retarding auxiliary agents, antistatic agents, anticlouding agents, fillers, softening agents, plasticizing agents, or coloring agents, may be added as necessary. With regard to these additives, a single type may be used by itself, or a combination of two or more types may be used.

Specific examples of the thermoplastic resins include polysulfone resins, polyethersulfone resins, polyimide resins, polyetherimide resins, phenoxy resins, or the like. With regard to the thermoplastic resins, a single type may be used by itself, or a combination of two or more types may be used.

The thermosetting resins include poly vinyl benzyl ether resins, reaction products obtained by reacting a bifunctional polyphenylene ether oligomer and chloromethylstyrene, or the like. Commercial items of the reaction products obtained by reacting the bifunctional polyphenylene ether oligomer and chloromethylstyrene include “OPE-2St”, which is a product name and which is manufactured by Mitsubishi Gas Chemical Co., Inc., or the like. With regard to the thermosetting resins, a single type may be used by itself, or a combination of two or more types may be used.

When the thermoplastic resins or the thermosetting resins are used, a preferable lower limit of the content of the thermoplastic resins or the thermosetting resins is 0.5 parts by weight to a total of 100 parts by weight of the epoxy resin and the curing agent; and a more preferable lower limit is 1 part by weight; and a preferable upper limit is 50 parts by weight; and a more preferable upper limit is 20 parts by weight. If the content of the thermoplastic resins or the thermosetting resins is too low, there are cases where the elongation and toughness of the cured body cannot be increased sufficiently. If the content of the thermoplastic resins or the thermosetting resins is too high, there are cases where the strength of the cured body deteriorates.

(Epoxy Resin Composition)

There is no particular limitation in the method for manufacturing the epoxy resin composition according to the present invention. The method for manufacturing the epoxy resin composition includes, for example, a method of adding, to a solvent, the epoxy resin, the curing agent, the silica component, and other components blended as necessary, such as the curing accelerator, the organically modified sheet silicate, and the like, drying the mixture, and removing the solvent from the mixture.

The epoxy resin composition according to the present invention may be used, for example, after being dissolved in a suitable solvent.

There is no particular limitation in the usage of the epoxy resin composition according to the present invention. The epoxy resin composition can be suitably used as, for example, a substrate material for forming a core layer, a build-up layer, or the like of a multilayer substrate, an adhesion sheet, a laminated plate, a resin-coated copper foil, a copper clad laminated plate, a TAB tape, a printed-circuit substrate, a prepreg, a varnish, or the like.

Furthermore, by using the epoxy resin composition according to the present invention, fine holes can be formed on the surface of the cured body obtained by performing a roughening treatment. Therefore, fine wirings can be formed on the surface of the cured body, and the signal transmission speed of the wirings can be increased. Thus, the epoxy resin composition can be suitable for usages requiring insulation characteristics, such as a resin-coated copper foil, a copper clad laminated plate, a printed-circuit substrate, a prepreg, an adhesion sheet, or a TAB tape.

The epoxy resin composition of the present invention is suitably used in build-up substrates or the like in which cured bodies and conductive plating layers are layered by using the additive process and the semi-additive process to form circuits after forming a conductive plating layer on the surface of the cured body. In such a case, joining reliability of the conductive plating layers and the cured bodies can be increased. Furthermore, since the holes that are formed as a result of the silica component being removed from the surface of the roughening-treated cured body are small, insulation reliability between patterns can be increased. Furthermore, since the depths of the holes obtained by removing the silica components are shallow, insulation reliability between layers can be increased. Therefore, highly reliable fine wirings can be formed.

The epoxy resin composition according to the present invention can also be used as a sealing material, a solder resist, or the like. Furthermore, since high-speed signal transmission performance of the wirings formed on the surface of the cured body can be enhanced, the epoxy resin composition of the present invention can also be used for a parts-built-in substrate having built-in passive parts or active parts requiring excellent high frequency characteristics.

(Prepreg)

The prepreg of the present invention is a prepreg obtained by impregnation of the epoxy resin composition to a porous base material.

There is no particular limitation in the porous base material as long as it can be impregnated with the epoxy resin composition. The porous base material includes an organic fiber, a glass fiber, or the like. The organic fiber includes a carbon fiber, a polyamide fiber, a polyaramid fiber, a polyester fiber, or the like. Furthermore, the form of the porous base material includes textile forms such as textiles of plain weave fabrics or twill fabrics, forms such as nonwoven fabrics, or the like. The porous base material is preferably a glass fiber nonwoven fabric.

(Cured Body)

By preliminary-curing (semi-curing) the present invention's epoxy resin composition or the prepreg obtained by impregnation of the epoxy resin composition to a porous base material, a preliminary-cured object can be obtained. By performing a roughening treatment on the obtained preliminary-cured object, a cured body can be obtained.

The obtained preliminary-cured object is in a semi-cured state generally referred to as B stage. In the present specification, “preliminary-cured object” refers to those ranging from a semi-cured object to a cured object that is in a completely cured state.

Specifically, the cured body of the present invention is obtained as follows.

The preliminary-cured object is obtained by preliminary-curing the epoxy resin composition or the prepreg in order to form fine concavities and convexities on the surface of the cured body on which the metal layer is formed. In order to adequately conduct the preliminary-curing, the epoxy resin composition or the prepreg is preferably heated to be preliminary-cured.

A heating temperature when conducting the preliminary-curing of the epoxy resin composition is preferably within a range between 130° C. to 190° C. If the heating temperature is lower than 130° C., the concavities and convexities on the surface of the cured body after a roughening treatment become large since the epoxy resin composition is not sufficiently cured. If the heating temperature is higher than 190° C., the curing reaction of the epoxy resin composition tends to proceed rapidly. Therefore, the degree of curing tends to differ locally, and rough portions and dense portions tend to be formed. As a result, the concavities and convexities on the surface of the cured body after a roughening treatment become large.

When Tg (1) represents a glass transition temperature upon preliminary-curing measured by a dynamic viscoelasticity device, and Tg (2) represents a glass transition temperature upon final curing measured by the dynamic viscoelasticity device, Tg (1)/Tg (2) is preferably equal to or higher than 0.6. Thus, the cured body is preferably cured such that the above described Tg (1)/Tg (2) is equal to or higher than 0.6. If the above described Tg (1)/Tg (2) is equal to or higher than 0.6, the surface roughness of the surface of the cured body after a roughening treatment and after the final curing can be further reduced.

The heating time for the preliminary-curing of the epoxy resin composition is preferably equal to or longer than 30 minutes. If the heating time is shorter than 30 minutes, the concavities and convexities on the surface of the cured body after a roughening treatment tend to become large since the epoxy resin composition is not sufficiently cured. From a standpoint of productivity, the heating time is preferably equal to or shorter than one hour.

A roughening treatment is conducted on the preliminary-cured object in order to form fine concavities and convexities on the surface of the obtained preliminary-cured object. Before performing the roughening treatment, a swelling treatment is preferably conducted on the preliminary-cured object. The cured body is preferably swelling-treated after the preliminary-curing and before the roughening treatment, and cured after the roughening treatment. However, the swelling treatment may not necessarily be conducted on the preliminary-cured object.

As the method for the swelling treatment, for example, a method of treating the preliminary-cured object by using an aqueous solution or organic solvent dispersed solution of a compound having ethylene glycol or the like as the main component may be used. Specifically, the swelling treatment is conducted by treating the preliminary-cured object by using a 40 wt % ethylene glycol aqueous solution at a treating temperature between 30° C. to 85° C. for 1 to 20 minutes. The temperature of the swelling treatment is preferably within a range between 50° C. to 85° C. If the temperature of the swelling treatment is too low, a prolonged time will be required for the roughening treatment, and the post-roughened adhesive strength of the cured body and the metal layer tends to be low.

For the roughening treatment, for example, chemical oxidants such as a manganese compound, a chromium compound, a persulfuric acid compound, or the like can be used. These chemical oxidants are added to water or an organic solvent, and used as an aqueous solution or organic solvent dispersed solution.

The manganese compound includes potassium permanganate, sodium permanganate, or the like. The chromium compound includes potassium dichromate, potassium chromate anhydride, or the like. The persulfuric acid compound includes sodium persulfate, potassium persulfate, ammonium persulfate, or the like.

There is no particular limitation in the method for the roughening treatment. Suitable as the method for the roughening treatment is, for example, a method of treating the preliminary-cured object once or twice by using a permanganic acid or permanganate solution of 30 to 90 g/L and a sodium hydroxide solution of 30 to 90 g/L and by using a condition of a treating temperature of 30° C. to 85° C. for 1 to 10 minutes. The temperature of the roughening treatment is preferably within a range between 50° C. to 85° C. If the temperature for the roughening treatment is too low, a prolonged time will be required for the roughening treatment, and the post-roughened adhesive strength between the cured body and the metal layer tends to be low. If the roughening treatment is conducted for a large number of times, the roughening effect is also becomes large. However, if the number of roughening treatments exceeds three, the roughening effect may reach saturation, or the resin component on the surface of the cured body is removed more than necessary and the holes on the surface of the cured body tend not to be formed in the shape obtained by eliminating the silica component.

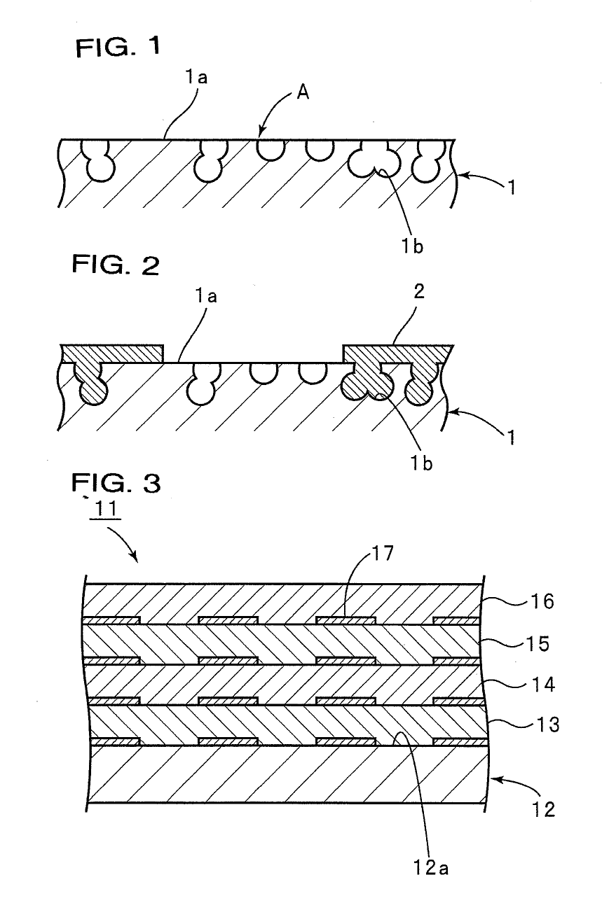

FIG. 1 a partially-cut front sectional view that schematically shows a surface of a cured body obtained by preliminary-curing an epoxy resin composition according to one embodiment of the present invention and then by performing a roughening treatment.

As shown in FIG. 1, holes 1b, which are formed by eliminating the silica component, are formed on a surface 1a of a cured body 1.

The epoxy resin composition according to the present invention has an excellent dispersibility of the silica component, since the silica component obtained by performing a surface treatment on the silica particles by using the above described specific amount of the silane coupling agent is included. Therefore, the cured body 1 obtained by performing a roughening treatment hardly forms large holes that result from elimination of silica component aggregates. Thus, the strength of the cured body 1 hardly deteriorates in a local manner, and the adhesive strength between the cured body and the metal layer can be increased. Furthermore, the silica component content can be increased in order to lower the linear expansion coefficient of the cured body 1, and a plurality of fine holes 1b can be formed on the surface of the cured body 1 even when the silica component content is high. However, the holes 1b may be holes that result from elimination of a couple of pieces of the silica component, for example, 2 to 10 pieces.

The resin component has not been removed more than necessary from a portion shown with arrow A in FIG. 1 in proximity of the holes 1b formed resulting from elimination of the silica component. If, in particular, a phenolic compound having a biphenyl structure, an active ester compound, or a compound having a benzoxazine structure is used as the curing agent, the resin component is relatively easily removed from the surfaces of the holes 1b formed resulting from elimination of the silica component. However, when the specific silica component is used, the resin component will not be removed more than necessary even if a phenolic compound having a biphenyl structure, an active ester compound, or a compound having a benzoxazine structure is used as the curing agent. Therefore, the strength of the cured body 1 can be increased.

With regard to the surface of the roughening-treated cured body obtained as described above, preferably, the arithmetic mean roughness Ra is equal to or less than 0.3 μm, and the ten-point mean roughness Rz is equal to or less than 3.0 μm. With regard to the surface of the cured body, the arithmetic mean roughness Ra is more preferably equal to or less than 0.2 μm, and even more preferably equal to or less than 0.15 μm. With regard to the surface of the cured body, the ten-point mean roughness Rz is preferably equal to or less than 2 μm, and even more preferably equal to or less than 1.5 μm. If the arithmetic mean roughness Ra is too large, or if the ten-point mean roughness Rz is too large, an increase in the transmission speed of electric signals through wirings formed on the surface of the cured body may not be achieved. The arithmetic mean roughness Ra and the ten-point mean roughness Rz can be obtained using measuring methods conforming to JIS B0601-1994.

The plurality of holes formed on the surface of the cured body preferably have a mean diameter equal to or less than 5 μm. If the mean diameter of the plurality of holes is larger than 5 μm, there will be cases where it will be difficult to form wirings having a small L/S on the surface of the cured body, and the formed wirings will easily short-circuit.

As necessary, the cured body obtained by performing a roughening treatment can be provided with an electrolysis plating, after being treated with a publicly known catalyst for metal plating or being provided with a nonelectrolytic plating. With this, a plating layer which serves as the metal layer can be formed on the surface of the cured body.

FIG. 2 shows a state at which a metal layer 2 is formed by plate processing on the surface of the roughening-treated cured body 1. As shown in FIG. 2, the metal layer 2 extends into the fine holes 1b formed on the surface 1a of the cured body 1. Therefore, as a result of a physical anchoring effect, the adhesive strength between the cured body 1 and the metal layer 2 can be increased. Furthermore, since the resin component is not removed more than necessary in the proximity of the holes 1b formed resulting from elimination of the silica components, the adhesive strength between the cured body 1 and the metal layer 2 can be increased.

The smaller the mean particle diameter of the silica component is, finer concavities and convexities can be formed on the surface of the cured body 1. By using the silica component obtained by performing a surface treatment on silica particles having a mean particle diameter of 1 μm using the silane coupling agent, the holes 1b can be reduced in size; and therefore, fine concavities and convexities can be formed on the surface of the cured body 1. Thus, the L/S indicating the degree of fineness of the circuit wirings can be reduced.

When copper wirings or the like having a small L/S are formed on the surface of the cured body 1, the signal processing speed of the wirings can be increased. For example, even for signals having a high frequency of 5 GHz or higher, loss of electric signals at an interface between the cured body 1 and the metal layer 2 can be reduced since the surface roughness of the cured body 1 is small.

When the L/S is smaller than 65 μm/65 μm, in particular, when the L/S is smaller than 45 μm/45 μm, the mean particle diameter of the silica particles is preferably equal to or less than 5 μm, and preferably equal to or less than 2 μm. Furthermore, when the L/S is smaller than 13 μm/13 μm, the mean particle diameter of the silica particles is preferably equal to or less than 2 μm, and more preferably equal to or less than 1 μm.

With the epoxy resin composition according to the present invention, since included is the silica component obtained by performing a surface treatment on the silica particles which have mean particle diameters equal to or less than 1 μm using the specific amount of the silane coupling agent, fine wirings having a small surface roughness variation and an L/S of, for example, around 13 μm/13 μm can be formed on the surface of the cured body. Furthermore, fine wirings having an L/S of 10 μm/10 μm or less can be formed on the surface of the cured body without resulting in a short circuit between the wirings. The cured body formed thereon with such wirings can transmit electric signals stably with small losses.

As a material for forming the metal layer, a metallic foil or a metal plating used for shielding or for circuit formation, or a metal plating material used for circuit protection can be used.

The plating material includes, for example, gold, silver, copper, rhodium, palladium, nickel, tin, or the like. An alloy of two or more of these may be used, or a metal layer having multiple layers may be formed by using two or more of these types of plating materials. Furthermore, depending on the purpose, metals or substances other than the above described metals may be included in the plating material.

(Sheet-Like Formed Body, Laminated Plate, and Multilayer Laminated Plate)

The sheet-like formed body of the present invention is a sheet-like formed body obtained by forming, into a sheet, the epoxy resin composition, the prepreg, or the cured body obtained by curing the epoxy resin composition or the prepreg.

Note that, in the present specification, “sheet” is one having a plate-like shape without any limits to the thickness and width, and the sheet also includes a film. An adhesive sheet is included in the “sheet-like formed body”.

A method for forming the epoxy resin composition into a sheet includes, for example: an extrusion method of fusing and kneading the epoxy resin composition using an extruder, and after extrusion, forming it into a film shape by using a T die, a circular die, or the like; a mold casting method of dissolving or dispersing the epoxy resin composition in a solvent such as an organic solvent, and casting and forming it into a film shape; or conventionally well-known other sheet forming methods or the like. Among these, the extrusion method or the mold casting method is preferable, since advanced thinning can be achieved.

A laminated plate of the present invention comprises the sheet-like formed body, and a metal layer laminated on at least one surface of the sheet-like formed body.

A multilayer laminated plate of the present invention comprises the sheet-like formed bodies forming a lamination, and at least one metal layer which is interposed between the sheet-like formed bodies. The multilayer laminated plate may further comprise a metal layer laminated on an outside surface of an outermost sheet-like formed body.

An adhesive layer may be disposed on at least one area of the sheet-like formed body of the laminated plate. Furthermore, an adhesive layer may be disposed on at least one area of the sheet-like formed bodies laminated in the multilayer laminated plate.

The metal layer of the laminated plate or the multilayer laminated plate is preferably formed as a circuit. In this case, reliability of the circuit can be increased since the adhesive strength between the sheet-like formed body and the metal layer is high.

The multilayer laminated plate using the epoxy resin composition according to one embodiment of the present invention is schematically shown as a partially-cut front sectional view in FIG. 3.

In a multilayer laminated plate 11 shown in FIG. 3, a plurality of cured bodies 13 to 16 are laminated on an upper surface 12a of a substrate 12. Metal layers 17 are formed in one area of the upper surfaces of the cured bodies 13 to 15 and not on the cured body 16 on the uppermost layer. Namely, a metal layer 17 is disposed in each of the interlayers of the laminated cured bodies 13 to 16. A lower metal layer 17 and an upper metal layer 17 are mutually connected by at least one of a via hole connection and a through hole connection, which are not shown.

In the multilayer laminated plate 11, the cured bodies 13 to 16 are formed by curing a sheet-like formed body obtained by forming, into a sheet, the epoxy resin composition according to one embodiment of the present invention. Therefore, fine holes which are not shown are formed on the surface of the cured bodies 13 to 16. In addition, the metal layers 17 extend into the fine holes. As a result, the adhesive strength between the metal layers 17 and the cured bodies 13 to 16 can be increased. Furthermore, for the multilayer laminated plate 11, a width-direction dimension (L) of the metal layers 17, and a dimension (S) in a width direction of a portion on which the metal layers 17 are not formed, can be reduced.

Note that, a film may be laminated on the surface of the above described sheet-like formed body or laminated plate for purposes such as transportation aid, and prevention of scratching or adherence of dust.

The film includes a resin coated paper, a polyester film, a polyethylene terephthalate (PET) film, a polybutylene terephthalate (PBT) film, a polypropylene (PP) film, or the like. Release processing to increase releasability may be conducted on the film as necessary.

A method of the release processing includes a method of including a silicon based compound, a fluorine based compound, a surfactant, or the like in the film, a method of providing concavities and convexities on the surface of the film, a method of applying, on the surface of the film, a substance having releasability such as a silicon based compound, a fluorine based compound, or a surfactant. The method of providing concavities and convexities on the surface of the film includes a method of embossing the surface of the film, or the like.

In order to protect the film, a protection film such as a resin coated paper, a polyester film, a PET film, or a PP film may be laminated on the film.

The present invention will be described specifically in the following by showing examples and comparative examples. The present invention is not limited to the following examples.

In the examples and comparative examples, materials shown in the following were used.

(Epoxy Resin)

Bisphenol A type epoxy resin (manufactured by Nippon Kayaku Co., Ltd; product name “RE-310S”)

(Curing Agent)

Phenol based curing agent having a biphenyl structure (manufactured by Meiwa Plastic Industries, Ltd.; product name “MEH7851-4H”; weight average molecular weight approximately 10,200; softening point 120° C. or higher; corresponding to the phenolic compound represented by the above described formula (7))

Active ester compound (manufactured by DIC Corp.; product name “EPICLON EXB9460S-65T”; toluene solution having 65 wt % solid content)

(Curing Accelerator)

Imidazole (1) (manufactured by Shikoku Chemicals Corp.; product name “2PN-CN”; 1-cyanoethyl-2-methylimidazole)

Imidazole (2) (manufactured by Shikoku Chemicals Corp.; product name “2P4 MHZ”; 2-phenyl-4-methyl-5-dihydroxymethylimidazole)

(Imidazole Silane Compound)

Imidazole silane (manufactured by Nippon Mining & Metals Co., Ltd.; product name “IM-1000”)

(Organically Modified Sheet Silicate)

Synthetic hectorite chemically treated with a trioctylmethylammonium salt (manufactured by CO—OP Chemical Co., Ltd.; product name “LUCENTITE STN”)

(Solvent)

N,N-dimethylformamide (DMF; special grade; manufactured by Wako Pure Chemical Industries, Ltd.)

(Silica Component)

Silica particles (mean particle diameter 0.3 μm; specific surface area 18 m²/g) and an amino silane coupling agent (manufactured by Shin-Etsu Chemical Co., Ltd.; product name “KBE-903”) were blended such that the amounts used for surface treatment per 1 g of the silica particles were values shown in the following Table 1; and then N,N-dimethylformamide (DMF; special grade; manufactured by Wako Pure Chemical Industries, Ltd.) was further added; and then the mixture was agitated for two hours at 40° C. and was kept for two days. As a result, 50 wt % DMF slurries (including one of 50 wt % of silica components (1) to (6) and DMF 50 wt %) of silica components (1) to (6), in which the silica particles were surface-treated by the amino silane coupling agent, were obtained.

TABLE 1

| | | Silica | Silica | Silica | Silica | Silica | Silica |
|---|---|---|---|---|---|---|---|
| | | Component | Component | Component | Component | Component | Component |
| Type | | (1) | (2) | (3) | (4) | (5) | (6) |
| Amount of Amino Silane Coupling Agent | g | 0.0051 | 0.0194 | 0.0408 | — | 0.0025 | 0.0459 |
| used for Surface Treatment per 1 g of Silica | | | | | | | |
| Particles | | | | | | | |
| Specific Surface Area of Silica Particles | m²/g | 18 | 18 | 18 | 18 | 18 | 18 |
| Minimum Coated Area of Amino Silane | m²/g | 353 | 353 | 353 | — | 353 | 353 |
| Coupling Agent | | | | | | | |
| C value per 1 g of Silica Particles | g | 0.051 | 0.051 | 0.051 | — | 0.051 | 0.051 |
| (Amount of Silane Coupling Agent used for | % | 10 | 38 | 80 | — | 5 | 90 |
| Surface Treatment per 1 g of Silica Particles/ | | | | | | | |
| C value per 1 g of Silica Particles) × 100 | | | | | | | |

Silica particles (mean particle diameter 0.3 μm; specific surface area 18 m²/g) and an epoxy silane coupling agent (3-glycidoxypropyltrimethoxysilane; manufactured by Shin-Etsu Chemical Co., Ltd.; product name “KBM-403”) were blended such that the amounts used for surface treatment per 1 g of the silica particles were values shown in the following Table 2; and then N,N-dimethylformamide (DMF; special grade; manufactured by Wako Pure Chemical Industries, Ltd.) was further added; and then the mixture was agitated for two hours at 40° C. and was kept for two days. As a result, 50 wt % DMF slurries (including one of 50 wt % of silica components (7) to (12) and DMF 50 wt %) of silica components (7) to (12), in which the silica particles were surface-treated by the epoxy silane coupling agent, were obtained.

TABLE 2

| | | Silica | Silica | Silica | Silica | Silica | Silica |
|---|---|---|---|---|---|---|---|
| | | Component | Component | Component | Component | Component | Component |
| Type | | (7) | (8) | (9) | (4) | (11) | (12) |
| Amount of Epoxy Silane Coupling Agent | g | 0.0051 | 0.0194 | 0.0408 | — | 0.0025 | 0.0459 |
| used for Surface Treatment per 1 g of Silica | | | | | | | |
| Particles | | | | | | | |
| Specific Surface Area of Silica Particles | m²/g | 18 | 18 | 18 | 18 | 18 | 18 |
| Minimum Coated Area of Epoxy Silane | m²/g | 353 | 353 | 353 | — | 353 | 353 |
| Coupling Agent | | | | | | | |
| C value per 1 g of Silica Particles | g | 0.051 | 0.051 | 0.051 | — | 0.051 | 0.051 |
| (Amount of Silane Coupling Agent used for | % | 10 | 38 | 80 | — | 5 | 90 |
| Surface Treatment per 1 g of Silica Particles/ | | | | | | | |
| C value per 1 g of Silica Particles) × 100 | | | | | | | |

### Example 1

46.45 g of the 50 wt % DMF slurry of silica component (2) and 10.43 g of DMF were mixed, and agitated at an ordinary temperature until it became a completely homogeneous solution. Then, 0.22 g of imidazole (1) (manufactured by Shikoku Chemicals Corp.; product name “2PN-CN”) was further added, and agitated at an ordinary temperature until it became a completely homogeneous solution.

Next, 19.24 g of a bisphenol A type epoxy resin (manufactured by Nippon Kayaku Co., Ltd.; product name “RE-310S”) was added, and agitated at an ordinary temperature until it became a completely homogeneous solution, and thereby a solution was obtained. 23.68 g of a phenol based curing agent having a biphenyl structure (manufactured by Meiwa Plastic Industries, Ltd.; product name “MEH7851-4H”) was added to the obtained solution, and agitated at an ordinary temperature until it became a completely homogeneous solution, and thereby the epoxy resin composition was prepared.

A transparent polyethylene terephthalate (PET) film on which release processing was conducted (product name “PET5011 550”; thickness 50 μm; manufactured by LINTEC Corp.) was prepared. The obtained epoxy resin composition was applied on this PET film by using an applicator such that its thickness after drying will be 50 μm. Next, the film was dried for 12 minutes at 100° C. inside a gear oven to prepare an un-cured object which is to be a resin sheet and which is length 200 mm×width 200 mm×thickness 50 μm. Next, the un-cured object which is to be a resin sheet was heated for one hour at 170° C. inside a gear oven to prepare a primary cured object which is to be a resin sheet.

### Examples 2 to 15 and Comparative Examples 1 to 11

Except for changing the used types of materials and blend amounts as shown in Tables 3 to 6, epoxy resin compositions were prepared, and un-cured objects, which are to be resin sheets, and primary cured objects, which are to be resin sheets, were produced similarly to Example 1. Note that, when an epoxy resin composition is to include an imidazole silane, the imidazole silane was added together with a curing agent.

(Preparation of Cured Body A)

The obtained un-cured objects, which are to be resin sheets, were vacuum-laminated on glass epoxy group plates (FR-4; stock number “CS-3665”; manufactured by Risho Kogyo Co., Ltd.), and preliminary-curing was conducted at 150° C. for 60 minutes to obtain laminated bodies of the glass epoxy group plates and preliminary-cured objects. Next, on the preliminary-cured objects, the below described (a) swelling treatment was conducted, and then the below described (b) permanganate treatment, which is a roughening treatment, was conducted, and then the below described (c) copper plating processing was conducted.

(a) Swelling Treatment:

The above described laminated bodies were placed in an 80° C. swelling liquid (Swelling Dip Securigant P; manufactured by Atotech Japan Co., Ltd.), and oscillated for 15 minutes. Then, the laminated bodies were rinsed using pure water.

(b) Permanganate Treatment:

The laminated bodies were placed in an 80° C. potassium permanganate (Concentrate Compact CP; manufactured by Atotech Japan Co., Ltd.) roughening solution, and oscillated for 15 minutes to obtain roughening-treated cured bodies on the glass epoxy group plates. The obtained cured bodies were rinsed for 2 minutes with a 25° C. rinsing liquid (Reduction Securigant P; manufactured by Atotech Japan Co., Ltd.), and then rinsed with pure.

(c) Copper Plating Processing:

Next, electroless copper plating processing and electrolytic copper plating processing were conducted for the roughening-treated cured bodies on the glass epoxy group plates, by using the following procedures.

The surfaces of the cured bodies were delipidated and rinsed by being treated with a 60° C. alkaline cleaner (Cleaner Securigant 902) for 5 minutes. After the rinsing, the cured bodies were treated with a 25° C. predip liquid (Pre-Dip Neogant B) for 2 minutes. Then, the cured bodies were treated with a 40° C. activator liquid (Activator Neogant 834) for 5 minutes in order to be provided with a palladium catalyst. Next, the cured bodies were treated with a 30° C. reduction liquid (Reducer Neogant WA) for 5 minutes.

Next, the cured bodies were placed in a chemically copper enriched liquid (Basic Printgant MSK-DK; Copper Printgant MSK; Stabilizer Printgant MSK) to apply a nonelectrolytic plating until the plating thickness was approximately 0.5 μm. After the nonelectrolytic plating, annealing was conducted for 30 minutes at a temperature of 120° C. in order to remove any residual hydrogen gas. All the processes up to the process of nonelectrolytic plating were conducted at a beaker scale with 1 L of processing liquids by oscillating the cured bodies.

Next, electrolysis platings were applied to the nonelectrolytic plating-processed cured bodies until the plating thickness was 25 μm. Copper sulfate (Reducer Cu) was used for the electrolytic copper plating, and an electric current of 0.6 A/cm² was passed therethrough. After the copper plating processing, the cured bodies were heated and cured for 1 hour at 180° C. to obtain cured bodies A each having a copper plating layer formed thereon.

(Preparation of Cured Body B)

The obtained primary cured objects which are to be resin sheets were heated and cured for 1 hour at 180° C. to obtain cured bodies B.

(Evaluation)

(1) Dielectric Constant and Dielectric Loss Tangent

Eight sheets of the obtained un-cured object were layered to obtain a laminated body having a thickness of 400 μm. The obtained laminated body was cured by heating for 1 hour at 170° C. and 1 hour at 180° C. inside a gear oven to obtain a cured body. The cured body was cut so as to have a plane shape of 15 mm×15 mm. Dielectric constant and dielectric loss tangent of the laminated body at 1 GHz frequency at an ordinary temperature (23° C.) were measured by using a dielectric constant measuring device (stock number “HP4291B”; manufactured by Hewlett-Packard Co.).

(2) Average Linear Expansion Coefficient

The obtained cured bodies B were cut so as to have plane shapes of 3 mm×25 mm. An average linear expansion coefficient (α1) at 23° C. to 100° C. and an average linear expansion coefficient (α2) at 150° C. to 260° C. of the cut cured bodies were measured by using a linear-expansion-coefficient meter (stock number “TMA/SS120C”; manufactured by Seiko Instruments Inc.) with conditions of tension load of 2.94×10⁻²N and a temperature increase rate of 5° C./minute.

(3) Glass Transition Temperature (Tg)

The obtained cured bodies B were cut so as to have plane shapes of 5 mm×3 mm. Loss rates tan δ of the cut cured bodies were measure by using a Viscoelasticity Spectro-Rheometer (stock number “RSA-II”; manufactured by Rheometric Scientific F. E. Ltd.) in a range from 30° C. to 250° C. with a condition of a temperature increase rate of 5° C./minute, and temperatures at which the loss rates tan δ become maximum values (glass transition temperature Tg) were obtained.

(4) Breaking Strength and Breaking Point Elongation Rate

The obtained cured bodies B were cut so as to have plane shapes of 10×80 mm to obtain test samples. Breaking strengths (MPa), and rates of elongation at breaking (%) of the test samples were measured by conducting tensile tests using a tensile testing machine (product name “Tensilon”; manufactured by Orientec Co., Ltd.) with conditions of 60 mm distance between chucks and a crosshead speed of 5 mm/minute.

(5) Post-Roughened Adhesive Strength

10 mm-width notches were made on the surfaces of the copper plating layers of the cured bodies A having the copper plating layers formed thereon. Then, adhesive strengths between the copper plating layers and the cured bodies were measured using a tensile testing machine (product name “Autograph”; manufactured by Shimadzu Corp.) with a condition of a crosshead speed of 5 mm/minute, and the obtained measured values were used as post-roughened adhesive strengths.

(6) Arithmetic Mean Roughness Ra and Ten-Point Mean Roughness Rz

Roughening-treated cured bodies, prior to having plating layers formed thereon, were prepared when obtaining the plating layer-formed cured bodies A. Arithmetic mean roughnesses Ra and ten-point average roughnesses Rz of the surfaces of the roughening-treated cured bodies were measured using a scanning laser microscope (stock number “1LM21”; manufactured by Lasertec Corp.) in a 100 μm² measurement area.

(7) Copper Adhesive Strength

The primary cured objects which are to be resin sheets were laminated on CZ treated copper foils (CZ-8301; manufactured by MEC Co., Ltd.) inside of a vacuum, heated for 1 hour at 180° C., and were cured to obtain cured bodies with copper foils. Then, 10 mm width notches were made on the surfaces of the copper foils. Adhesive strengths between copper foils and cured bodies were measured by using a tensile testing machine (product name “Autograph”; manufactured by Shimadzu Corp.) with a condition of a crosshead speed of 5 mm/minute, and the measured adhesive strengths were used as copper adhesive strengths.

(8) Volume Resistivity

The obtained cured bodies B were cut so as to have plane shapes of 100 mm×100 mm to obtain test samples having 50 μm thicknesses. The obtained test samples were exposed to a PCT condition of 134° C., 3 atm, and 2 hours. After the exposure, volume resistivities of the test samples were measured by connecting a high resistivity meter (manufactured by Mitsubishi Chemical Co., Ltd.; product name “Hiresta UP”) to a U-type J-Box.

The results are shown in the following Tables 3 to 6.

TABLE 3

| | | | | | | Comparative | Comparative | Comparative |
|---|---|---|---|---|---|---|---|---|
| | | | Example 1 | Example 2 | Example 3 | Example 1 | Example 2 | Example 3 |
| Blend | Epoxy Resin | Bisphenol A Type Epoxy | 19.24 | 19.24 | 19.24 | 19.24 | 19.24 | 19.24 |
| Component | | Resin | | | | | | |
| (Blend | Curing Agent | Phenol Based Curing Agent | 23.68 | 23.68 | 23.68 | 23.68 | 23.68 | 23.68 |
| Unit g) | | Having Biphenyl Structure | | | | | | |
| | Curing Accelerator | Imidazole (1) | 0.22 | 0.22 | 0.22 | 0.22 | 0.22 | 0.22 |
| | | Imidazole (2) | | | | | | |
| | 50 wt % DMF Slurry | 50 wt % DMF Slurry of Silica | | 46.45 | | | | |
| | of Silica Component | Component (1) | | | | | | |
| | | 50 wt % DMF Slurry of Silica | 46.45 | | | | | |
| | | Component (2) | | | | | | |
| | | 50 wt % DMF Slurry of Silica | | | 46.45 | | | |
| | | Component (3) | | | | | | |
| | | 50 wt % DMF Slurry of Silica | | | | 46.45 | | |
| | | Component (4) | | | | | | |
| | | 50 wt % DMF Slurry of Silica | | | | | 46.45 | |
| | | Component (5) | | | | | | |
| | | 50 wt % DMF Slurry of Silica | | | | | | 46.45 |
| | | Component (6) | | | | | | |
| | Organically Modified | Synthetic Hectorite | | | | | | |
| | Sheet Silicate | | | | | | | |
| | Solvent | N,N-dimethylformamide | 10.43 | 10.43 | 10.43 | 10.43 | 10.43 | 10.43 |
| | | (DMF) | | | | | | |
| Evaluation | Dielectric Constant | | 3.3 | 3.3 | 3.3 | 3.4 | 3.3 | 3.4 |
| | Dielectric Loss Tangent | | 0.017 | 0.017 | 0.018 | 0.020 | 0.018 | 0.019 |
| | Average Linear | α1 (×10⁵/° C.) | 43 | 43 | 44 | 45 | 44 | 46 |
| | Expansion Coefficient | α2 (×10⁵/° C.) | 142 | 143 | 140 | 150 | 149 | 155 |
| | Breaking Strength | (MPa) | 86 | 89 | 87 | 72 | 79 | 75 |
| | Breaking Point | (%) | 5.4 | 6.9 | 5.1 | 3.5 | 3.9 | 4.1 |
| | Elongation Rate | | | | | | | |
| | Post-Roughened | N/cm | 8.8 | 7.8 | 6.9 | 0.0 | 4.9 | 3.9 |
| | Adhesive Strength | | | | | | | |
| | Arithmetic Mean | μm | 0.07 | 0.09 | 0.05 | 0.65 | 0.38 | 0.16 |
| | Roughness Ra | | | | | | | |
| | Ten-Point Average | μm | 0.64 | 0.78 | 0.59 | 5.80 | 3.60 | 1.63 |
| | Roughness Rz | | | | | | | |
| | Copper Adhesive | N/cm | 8.8 | 8.8 | 10.8 | 5.9 | 6.9 | 10.8 |
| | Strength | | | | | | | |
| | Volume Resistivity | (×10¹⁴Ω · cm) | 65 | 43 | 76 | 0.3 | 3.9 | 78 |
| | Preliminary-Curing | (° C.) | 150 | 150 | 150 | 150 | 150 | 150 |
| | Temperature | | | | | | | |
| | Tg(1) after Preliminary- | (° C.) | 158 | 158 | 159 | 158 | 158 | 159 |
| | Curing | | | | | | | |
| | Tg(2) after Final Cure | (° C.) | 173 | 173 | 174 | 173 | 173 | 174 |

| | | | | | | |
|---|---|---|---|---|---|---|
| Tg(1)/Tg(2) | 0.91 | 0.91 | 0.91 | 0.91 | 0.91 | 0.91 |

TABLE 4

| | | | | | | | | Comparative | Comparative |
|---|---|---|---|---|---|---|---|---|---|
| | | | Example 4 | Example 5 | Example 6 | Example 7 | Example 8 | Example 4 | Example 5 |
| Blend | Epoxy Resin | Bisphenol A Type | 19.33 | 18.77 | 19.24 | 19.33 | 19.12 | 18.59 | 18.24 |
| Component | | Epoxy Resin | | | | | | | |
| (Blend | Curing Agent | Phenol Based Curing | 23.80 | 23.10 | 23.68 | 23.80 | 23.53 | 22.88 | 22.45 |
| Unit g) | | Agent Having Biphenyl | | | | | | | |
| | | Structure | | | | | | | |
| | Curing Accelerator | Imidazole (1) | 0.01 | 1.26 | | | 0.21 | 1.66 | 2.44 |
| | | Imidazole (2) | | | 0.22 | | | | |
| | 50 wt % DMF | 50 wt % DMF Slurry of | | | | | | | |
| | Slurry of Silica | Silica Component (1) | | | | | | | |
| | Component | 50 wt % DMF Slurry of | 46.45 | 46.45 | 46.45 | 46.45 | 46.45 | 46.45 | 46.45 |
| | | Silica Component (2) | | | | | | | |
| | | 50 wt % DMF Slurry of | | | | | | | |
| | | Silica Component (3) | | | | | | | |
| | | 50 wt % DMF Slurry of | | | | | | | |
| | | Silica Component (4) | | | | | | | |
| | | 50 wt % DMF Slurry of | | | | | | | |
| | | Silica Component (5) | | | | | | | |
| | | 50 wt % DMF Slurry of | | | | | | | |
| | | Silica Component (6) | | | | | | | |
| | Organically | Synthetic Hectorite | | | | | 0.27 | | |
| | Modified Sheet | | | | | | | | |
| | Silicate | | | | | | | | |
| | Solvent | N,N-dimethylformamide | 10.42 | 10.43 | 10.43 | 10.43 | 10.42 | 10.43 | 10.43 |
| | | (DMF) | | | | | | | |
| Evaluation | Dielectric Constant | | 3.3 | 33 | 3.3 | 3.4 | 3.3 | 3.4 | 3.5 |
| | Dielectric Loss Tangent | | 0.018 | 0.016 | 0.016 | 0.019 | 0.016 | 0.019 | 0.020 |
| | Average Linear | α1 (×10⁵/° C.) | 45 | 42 | 43 | 45 | 38 | 45 | 49 |
| | Expansion | α2 (×10⁵/° C.) | 145 | 137 | 142 | 148 | 118 | 150 | 159 |
| | Coefficient | | | | | | | | |
| | Breaking Strength | (MPa) | 84 | 88 | 89 | 82 | 94 | 81 | 75 |
| | Breaking Point | (%) | 7.1 | 5.0 | 4.9 | 5.4 | 4.2 | 4.2 | 3.9 |
| | Elongation Rate | | | | | | | | |
| | Post-Roughened | N/cm | 7.8 | 7.8 | 8.8 | 6.9 | 9.8 | 3.9 | 2.9 |
| | Adhesive Strength | | | | | | | | |
| | Arithmetic Mean | μm | 0.06 | 0.21 | 0.08 | 0.05 | 0.11 | 0.36 | 0.45 |
| | Roughness Ra | | | | | | | | |
| | Ten-Point Average | μm | 0.61 | 1.98 | 0.75 | 0.56 | 0.85 | 3.78 | 4.36 |
| | Roughness Rz | | | | | | | | |
| | Copper Adhesive | N/cm | 8.8 | 9.8 | 8.8 | 7.8 | 7.8 | 6.9 | 5.9 |
| | Strength | | | | | | | | |
| | Volume Resistivity | (×10¹⁴ Ω · cm) | 48 | 71 | 58 | 31 | 56 | 32 | 24 |
| | Preliminary-Curing | (° C.) | 150 | 150 | 150 | 150 | 150 | 150 | 150 |
| | Temperature | | | | | | | | |
| | Tg(1) after | (° C.) | 155 | 160 | 158 | 152 | 158 | 158 | 155 |
| | Preliminary-Curing | | | | | | | | |
| | Tg(2) after Final | (° C.) | 171 | 174 | 173 | 169 | 174 | 172 | 169 |
| | Cure | | | | | | | | |

| | | | | | | | |
|---|---|---|---|---|---|---|---|
| Tg(1)/Tg(2) | 0.91 | 0.92 | 0.91 | 0.90 | 0.91 | 0.91 | 0.92 |

TABLE 5

| | | | | Example | Example | Example |
|---|---|---|---|---|---|---|
| | | | Example 9 | 10 | 11 | 12 |
| Blend | Epoxy Resin | Bisphenol A Type Epoxy Resin | 20.16 | 20.16 | 20.16 | 20.16 |
| Component | Curing Agent | Phenol Based Curing Agent Having Biphenyl | 22.75 | 22.75 | 22.75 | 22.75 |
| (Blend | | Structure | | | | |
| Unit g) | Curing Accelerator | Imidazole (1) | 22 | 0.22 | 0.22 | 0.22 |
| | | Imidazole (2) | | | | |
| | 50 wt % DMF Slurry of Silica | 50 wt % DMF Slurry of Silica Component (7) | | 46.45 | | |
| | Component | 50 wt % DMF Slurry of Silica Component (8) | 46.45 | | | 46.45 |
| | | 50 wt % DMF Slurry of Silica Component (9) | | | 46.45 | |
| | | 50 wt % DMF Slurry of Silica Component (10) | | | | |
| | | 50 wt % DMF Slurry of Silica Component (11) | | | | |
| | | 50 wt % DMF Slurry of Silica Component (12) | | | | |
| | Organically Modified Sheet Silicate | Synthetic Hectorite | | | | |
| | Imidazole Silane | | | | | 0.15 |
| | Solvent | N,N-dimethylformamide (DMF) | 10.43 | 10.43 | 10.43 | 10.43 |
| Evaluation | Dielectric Constant | | 3.2 | 3.2 | 3.3 | 3.2 |
| | Dielectric Loss Tangent | | 0.016 | 0.017 | 0.018 | 0.016 |
| | Average Linear Expansion Coefficient | α1 (×10⁵/° C.) | 43 | 44 | 44 | 42 |
| | | α2 (×10⁵/° C.) | 140 | 141 | 139 | 138 |
| | Breaking Strength | (MPa) | 88 | 89 | 86 | 92 |
| | Breaking Point Elongation Rate | (%) | 5.1 | 5.9 | 4.8 | 5.0 |
| | Post-Roughened Adhesive Strength | N/cm | 7.8 | 6.7 | 7.8 | 9.8 |
| | Arithmetic Mean Roughness Ra | μm | 0.16 | 0.2 | 0.1 | 0.08 |
| | Ten-Point Average Roughness Rz | μm | 0.96 | 1.46 | 0.82 | 0.72 |
| | Copper Adhesive Strength | N/cm | 7.8 | 7.8 | 8.8 | 9.8 |
| | Volume Resistivity | (×10¹⁴ Ω · cm) | 130 | 53 | 170 | 160 |
| | Preliminary-Curing Temperature | (° C.) | 150 | 150 | 150 | 150 |
| | Tg(1) after Preliminary-Curing | (° C.) | 158 | 158 | 158 | 160 |
| | Tg(2) after Final Cure | (° C.) | 174 | 174 | 175 | 180 |

| | | | | |
|---|---|---|---|---|
| Tg(1)/Tg(2) | 0.91 | 0.91 | 0.90 | 0.89 |

| | | | Comparative | Comparative | Comparative |
|---|---|---|---|---|---|
| | | | Example 6 | Example 7 | Example 8 |
| Blend | Epoxy Resin | Bisphenol A Type Epoxy Resin | 20.16 | 20.16 | 20.16 |
| Component | Curing Agent | Phenol Based Curing Agent Having Biphenyl | 22.75 | 22.75 | 22.75 |
| (Blend | | Structure | | | |
| Unit g) | Curing Accelerator | Imidazole (1) | 0.22 | 0.22 | 0.22 |
| | | Imidazole (2) | | | |
| | 50 wt % DMF Slurry of Silica | 50 wt % DMF Slurry of Silica Component (7) | | | |
| | Component | 50 wt % DMF Slurry of Silica Component (8) | | | |
| | | 50 wt % DMF Slurry of Silica Component (9) | | | |
| | | 50 wt % DMF Slurry of Silica Component (10) | 46.45 | | |
| | | 50 wt % DMF Slurry of Silica Component (11) | | 46.45 | |
| | | 50 wt % DMF Slurry of Silica Component (12) | | | 46.45 |
| | Organically Modified Sheet Silicate | Synthetic Hectorite | | | |
| | Imidazole Silane | | | | |
| | Solvent | N,N-dimethylformamide (DMF) | 10.43 | 10.43 | 10.43 |

| | | | | |
|---|---|---|---|---|
| Evaluation | Dielectric Constant | 3.4 | 3.2 | 3.4 |
| | Dielectric Loss Tangent | 0.019 | 0.017 | 0.019 |

| | | | | |
|---|---|---|---|---|
| Average Linear Expansion Coefficient | α1 (×10⁵/° C.) | 46 | 44 | 47 |
| | α2 (×10⁵/° C.) | 151 | 148 | 154 |
| Breaking Strength | (MPa) | 73 | 78 | 76 |
| Breaking Point Elongation Rate | (%) | 3.2 | 3.6 | 3.8 |
| Post-Roughened Adhesive Strength | N/cm | 0.0 | 4.9 | 3.6 |
| Arithmetic Mean Roughness Ra | μm | 0.63 | 0.46 | 0.2 |
| Ten-Point Average Roughness Rz | μm | 5.68 | 4.16 | 2.26 |
| Copper Adhesive Strength | N/cm | 5.9 | 5.9 | 8.8 |
| Volume Resistivity | (×10¹⁴ Ω · cm) | 0.4 | 10 | 190 |
| Preliminary-Curing Temperature | (° C.) | 150 | 150 | 150 |
| Tg(1) after Preliminary-Curing | (° C.) | 158 | 157 | 159 |
| Tg(2) after Final Cure | (° C.) | 173 | 174 | 175 |

| | | | |
|---|---|---|---|
| Tg(1)/Tg(2) | 0.91 | 0.90 | 0.91 |

TABLE 6

| | | | Example 13 | Example 14 | Example 15 |
|---|---|---|---|---|---|
| Blend Component | Epoxy Resin | Bisphenol A Type Epoxy Resin | 20.99 | 20.99 | 20.99 |
| (Blend Unit g) | Curing Agent | Phenol Based Curing Agent Having Biphenyl | 33.72 | 33.72 | 33.72 |
| | | Structure | | | |
| | Curing Accelerator | Imidazole (1) | 0.22 | 0.22 | 0.22 |
| | | Imidazole (2) | | | |
| | 50 wt % DMF Slurry of Silica | 50 wt % DMF Slurry of Silica Component (7) | | 46.45 | |
| | Component | 50 wt % DMF Slurry of Silica Component (8) | 46.45 | | |
| | | 50 wt % DMF Slurry of Silica Component (9) | | | 46.45 |
| | | 50 wt % DMF Slurry of Silica Component (10) | | | |
| | | 50 wt % DMF Slurry of Silica Component (11) | | | |
| | | 50 wt % DMF Slurry of Silica Component (12) | | | |
| | Organically Modified Sheet Silicate | Synthetic Hectorite | | | |
| | Imidazole Silane | | | | |
| | Solvent | N,N-dimethylformamide (DMF) | 10.43 | 10.43 | 10.43 |
| Evaluation | Dielectric Constant | | 3.1 | 3.1 | 3.1 |
| | Dielectric Loss Tangent | | 0.007 | 0.008 | 0.007 |
| | Average Linear Expansion Coefficient | α1 (×10⁵/° C.) | 41 | 42 | 41 |
| | | α2 (×10⁵/° C.) | 148 | 150 | 146 |
| | Breaking Strength | (MPa) | 98 | 95 | 100 |
| | Breaking Point Elongation Rate | (%) | 3.9 | 3.5 | 3.8 |
| | Post-Roughened Adhesive Strength | N/cm | 7.8 | 6.9 | 7.8 |
| | Arithmetic Mean Roughness Ra | μm | 0.1 | 0.14 | 0.09 |
| | Ten-Point Average Roughness Rz | μm | 1.08 | 1.46 | 0.94 |
| | Copper Adhesive Strength | N/cm | 6.9 | 6.9 | 7.8 |
| | Volume Resistivity | (×10¹⁴ Ω · cm) | 160 | 65 | 195 |
| | Preliminary-Curing Temperature | (° C.) | 150 | 150 | 150 |
| | Tg(1) after Preliminary-Curing | (° C.) | 142 | 142 | 143 |
| | Tg(2) after Final Cure | (° C.) | 161 | 160 | 162 |
| | Tg(1)/Tg(2) | | 0.88 | 0.89 | 0.88 |
| | | | Comparative | Comparative | Comparative |
| | | | Example 9 | Example 10 | Example 11 |
| Blend Component | Epoxy Resin | Bisphenol A Type Epoxy Resin | 20.99 | 20.99 | 20.99 |
| (Blend Unit g) | Curing Agent | Phenol Based Curing Agent Having Biphenyl | 33.72 | 33.72 | 33.72 |
| | | Structure | | | |
| | Curing Accelerator | Imidazole (1) | 0.22 | 0.22 | 0.22 |
| | | Imidazole (2) | | | |
| | 50 wt % DMF Slurry of Silica | 50 wt % DMF Slurry of Silica Component (7) | | | |
| | Component | 50 wt % DMF Slurry of Silica Component (8) | | | |
| | | 50 wt % DMF Slurry of Silica Component (9) | | | |
| | | 50 wt % DMF Slurry of Silica Component (10) | 46.45 | | |
| | | 50 wt % DMF Slurry of Silica Component (11) | | 46.45 | |
| | | 50 wt % DMF Slurry of Silica Component (12) | | | 46.45 |
| | Organically Modified Sheet Silicate | Synthetic Hectorite | | | |
| | Imidazole Silane | | | | |
| | Solvent | N,N-dimethylformamide (DMF) | 10.43 | 10.43 | 10.43 |
| Evaluation | Dielectric Constant | | 3.2 | 3.1 | 3.1 |
| | Dielectric Loss Tangent | | 0.009 | 0.007 | 0.007 |
| | Average Linear Expansion Coefficient | α1 (×10⁵/° C.) | 45 | 44 | 42 |
| | | α2 (×10⁵/° C.) | 155 | 152 | 144 |
| | Breaking Strength | (MPa) | 86 | 93 | 94 |
| | Breaking Point Elongation Rate | (%) | 2.5 | 3.3 | 3.1 |
| | Post-Roughened Adhesive Strength | N/cm | 0.0 | 3.9 | 4.1 |
| | Arithmetic Mean Roughness Ra | μm | 0.46 | 0.34 | 0.18 |
| | Ten-Point Average Roughness Rz | μm | 4.20 | 3.56 | 1.92 |
| | Copper Adhesive Strength | N/cm | 3.9 | 4.9 | 7.8 |
| | Volume Resistivity | (×10¹⁴ Ω · cm) | 5.2 | 26 | 210 |
| | Preliminary-Curing Temperature | (° C.) | 150 | 150 | 150 |
| | Tg(1) after Preliminary-Curing | (° C.) | 139 | 141 | 143 |
| | Tg(2) after Final Cure | (° C.) | 157 | 161 | 162 |

| | | | |
|---|---|---|---|
| Tg(1)/Tg(2) | 0.89 | 0.88 | 0.88 |

### DESCRIPTION OF THE REFERENCE CHARACTERS

1 . . . cured body
1a . . . upper surface
1b . . . hole
2 . . . metal layer
11 . . . multilayer laminated plate
12 . . . substrate
12a . . . upper surface
13 to 16 . . . cured body
17 . . . metal layer

1. An epoxy resin composition comprising
an epoxy resin, a curing agent, and a silica component in which silica particles are surface treated with a silane coupling agent,
the epoxy resin composition not comprising a curing accelerator, or comprising a curing accelerator at a content equal to or less than 3.5 parts by weight to a total of 100 parts by weight of the epoxy resin and the curing agent,
a mean particle diameter of the silica particle being equal to or less than 1 μm,
an amount B (g) of the silane coupling agent used for surface treatment, per 1 g of the silica particles in the silica component, being within a range between 10% to 80% with regard to a value C (g) per 1 g of the silica particles, which is calculated by the following formula (X).
C (g)/1 g of Silica Particles=[Specific Surface Area of Silica Particles (m²/g)/Minimum Area Coated by Silane Coupling Agent (m²/g)] Formula (X)

2. The epoxy resin composition according to claim 1, wherein the epoxy resin composition comprises the silica component within a range between 10 to 400 parts by weight to a total of 100 parts by weight of the epoxy resin and the curing agent.

3. The epoxy resin composition according to claim 1, wherein the curing agent is at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins.

4. The epoxy resin composition according to claim 1, wherein the curing accelerator is an imidazole compound.

5. The epoxy resin composition according to claim 4, wherein the curing accelerator is at least one type selected from the group consisting of 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2,4-diamino-6-[2′-methyl imidazolyl-(1′)]-ethyl-s-triazine, 2,4-diamino-6-[2′-undecyl imidazolyl-(1′)]-ethyl-s-triazine, 2,4-diamino-6-[2′-ethyl-4′-methyl imidazolyl-(1′)]-ethyl-s-triazine, adducts of 2,4-diamino-6-[2′-methyl imidazolyl-(1′)]-ethyl-s-triazine isocyanuric acid, adducts of 2-phenyl imidazole isocyanuric acid, adducts of 2-methyl imidazole isocyanuric acid, 2-phenyl-4,5-dihydroxymethylimidazole, and 2-phenyl-4-methyl-5-dihydroxymethylimidazole.

6. The epoxy resin composition according to claim 1, further comprising an imidazole silane compound within a range between 0.01 to 3 parts by weight to a total of 100 parts by weight of the epoxy resin and the curing agent.

7. The epoxy resin composition according to claim 1, further comprising an organically modified sheet silicate within a range between 0.01 to 3 parts by weight to a total of 100 parts by weight of the epoxy resin and the curing agent.

8. A prepreg obtained by impregnation of the epoxy resin composition according to claim 1, to a porous base material.

9. A cured body obtained by preliminary-curing the epoxy resin composition according to claim 1 or a prepreg obtained by impregnation of the epoxy resin composition to a porous base material, and then performing a roughening treatment thereon;
the cured body having a surface on which a roughening treatment is performed and which has an arithmetic mean roughness Ra equal to or less than 0.3 μm and a ten-point mean roughness Rz equal to or less than 3.0 μm.

10. The cured body according to claim 9, wherein a swelling treatment is performed after the preliminary-curing but before the roughening treatment, and additionally, curing is performed after the roughening treatment.

11. A sheet-like formed body obtained by forming, into a sheet, the epoxy resin composition according to claim 1, a prepreg obtained by impregnation of the epoxy resin composition to a porous base material, or a cured body obtained by preliminary-curing the epoxy resin composition or the prepreg and then performing a roughening treatment thereon.

12. A laminated plate comprising the sheet-like formed body according to claim 11, and a metal layer laminated on at least one surface of the sheet-like formed body.

13. The laminated plate according to claim 12, wherein the metal layer is formed as a circuit.

14. A multilayer laminated plate comprising a plurality of the sheet-like formed bodies according to claim 10 which are laminated onto each other, and at least one metal layer which is interposed between the sheet-like formed bodies.

15. The multilayer laminated plate according to claim 14, further comprising a metal layer laminated on an outside surface of an outermost sheet-like formed body out of the sheet-like formed bodies.

16. The multilayer laminated plate according to claim 14, wherein the metal layer is formed as a circuit.
